(19) United States
(12) Patent Application Publication
(10) Pub. No.: US 2026/0001296 A1
(43) Pub. Date: Jan. 1, 2026

(54) MEDIUM PROCESSING APPARATUS AND IMAGE FORMING SYSTEM

(71) Applicant: Ryo TAKAHASHI, Kanagawa (JP)

(72) Inventor: Ryo TAKAHASHI, Kanagawa (JP)

(73) Assignee: Ricoh Company, Ltd., Tokyo (JP)

(21) Appl. No.: 19/235,269

(22) Filed: Jun. 11, 2025

(30) Foreign Application Priority Data
Jun. 27, 2024 (JP) 2024-103844

(51) Int. Cl. B31F 1/36; B31F 5/02; G03G 15/00

(52) U.S. Cl. CPC B31F 1/36; B31F 5/02; G03G 15/6544

(57) ABSTRACT

A medium processing apparatus includes a tray, a liquid applier, a crimper, and circuitry. The crimper crimps and binds a media bundle including the medium to which the liquid is applied by the liquid applier as a binding process. The circuitry is to measure an elapsed time after the application process is executed on a first medium of the media bundle, control the liquid applier to reapply the liquid to the first medium as a reapplication process when the elapsed time reaches a threshold time before a second medium is conveyed to the tray, control the liquid applier not to reapply the liquid to the first medium as the reapplication process when the second medium is conveyed to the tray before the elapsed time reaches the threshold time, and control the crimper to execute the binding process on the media bundle including the first medium and the second medium.

### CROSS-REFERENCE TO RELATED APPLICATION

This patent application is based on and claims priority pursuant to 35 U.S.C. § 119(a) to Japanese Patent Application No. 2024-103844, filed on Jun. 27, 2024, in the Japan Patent Office, the entire disclosure of which is hereby incorporated by reference herein.

### BACKGROUND

### Technical Field

Embodiments of the present disclosure relate to a medium processing apparatus and an image forming system.

### Related Art

Media processing apparatuses are known in the related art that bind sheet-shaped media, on which images are formed by image forming apparatuses, into a bundle of media. Some media processing apparatuses include a crimper that can perform so-called “crimp binding” without metal binding needles from a viewpoint of resource saving and reduction in environmental load. Specifically, the crimper sandwiches a sheet bundle (multiple media) with serrate binding teeth to press and deform the sheet bundle.

An increased number of media of the crimper hamper the binding teeth in biting into the medium bundle and may cause some sheets to peel off from the bound sheets. Thus, the crimp binding has some difficulties in keeping the medium bundle bound as appropriate. Accordingly, in order to facilitate biting of the binding tooth into a medium bundle, some of medium processing apparatuses that perform crimp binding include a liquid applier that applies liquid in advance to a position at which binding teeth come into contact with the sheet.

However, when a long time elapses without being crimped and bound due to a trouble such as paper jamming of the medium in the conveyance path (so-called jam), the liquid applied to the medium evaporates. Therefore, if crimping and binding is performed after the trouble is solved, there is a problem that it is difficult to obtain appropriate binding strength.

### SUMMARY

Embodiments of the present disclosure described herein provide a novel medium processing apparatus includes a tray, a liquid applier, a crimper, and circuitry. The liquid applier applies liquid to a medium supported by the tray as an application process. The crimper crimps and binds a media bundle including the medium to which the liquid is applied by the liquid applier as a binding process. The circuitry is to measure an elapsed time after the application process is executed on a first medium of the media bundle, control the liquid applier to reapply the liquid to the first medium as a reapplication process when the elapsed time reaches a threshold time before a second medium subsequent to the first medium is conveyed to the tray, control the liquid applier not to reapply the liquid to the first medium as the reapplication process when the second medium is conveyed to the tray before the elapsed time reaches the threshold time, and control the crimper to execute the binding process on the media bundle including the first medium and the second medium.

Further, embodiments of the present disclosure described herein provide an image forming system including an image forming apparatus to form an image on a medium, the above-described medium processing apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming system;

FIG. 2 is a diagram illustrating an internal structure of a post-processing apparatus according to a first embodiment;

FIG. 3 is a schematic view of an edge binder viewed from an upstream side in a conveyance direction;

FIG. 4 is a schematic view illustrating the edge binder of FIG. 3, viewed from a liquid applier in a main scanning direction;

FIGS. 5A and 5B are schematic views illustrating a configuration of a crimper of the edge binder;

FIG. 6 is a schematic view of a staple binder viewed from an upstream side in a conveyance direction;

FIG. 7 is a schematic view of a modification of the staple binder viewed from the upstream side in the conveyance direction;

FIGS. 8A and 8B are views illustrating a location and configuration of a second liquid storage tank in the post-processing apparatus;

FIG. 9 including parts FIGS. 9(A), 9(B), and 9(C) is a diagram illustrating a configuration of attachment and detachment of a second liquid storage tank in the post-processing apparatus;

FIG. 10 is a hardware configuration diagram of a control block to control the post-processing apparatus according to the first embodiment;

FIG. 11 is a flowchart of a binding process performed by the edge binder;

FIGS. 12A, 12B, and 12C are diagrams illustrating positions of the liquid applier and the crimper during the binding process by the edge binder;

FIG. 13 is a diagram illustrating a configuration of a liquid application unit included in the liquid applier of the edge binder;

FIGS. 14A, 14B, and 14C are diagrams illustrating a change in the amount of liquid in a liquid storage tank in a dry state of a liquid supply member of the liquid application unit of FIG. 13;

FIG. 15 is a flowchart of a liquid supply determination process according to the first embodiment;

FIG. 16 is a diagram illustrating liquid leakage that might occur in a first liquid storage tank according to the first embodiment;

FIG. 17 is a graph illustrating a relation between an output value of a first liquid-level sensor and a liquid detection threshold value in a time series manner according to the first embodiment;

FIG. 18 is a table indicating a data example of a threshold time;

FIG. 19 is a table indicating a data example of a pressing time;

FIGS. 20A and 20B are screen examples of a reapplication setting screen (A) and a pressing time setting screen (B);

FIG. 21 is a flowchart of a binding process according to a modification;

FIG. 22 is a diagram illustrating an internal structure of a post-processing apparatus according to a second embodiment;

FIGS. 23A, 23B, and 23C are schematic views of an internal tray according to the second embodiment, viewed from a thickness direction of a sheet;

FIG. 24 is a schematic view of a crimper according to the second embodiment, viewed from a downstream side in a conveyance direction;

FIGS. 25A and 25B are schematic views of a liquid applier according to the second embodiment, viewed from a thickness direction of a sheet;

FIGS. 26A, 26B, and 26C are cross-sectional views taken along XXV-XXV of FIG. 25A;

FIGS. 27A, 27B, and 27C are cross-sectional views taken along XXVI-XXVI of FIG. 25A;

FIG. 28 is a hardware configuration diagram of a control block of the post-processing apparatus according to the second embodiment;

FIG. 29 is a flowchart of post-processing of the post-processing apparatus according to the second embodiment;

FIG. 30 is a diagram illustrating an overall configuration of a modification of the image forming system;

FIGS. 31A and 31B are diagrams illustrating Modification 1 of a controller of the post-processing apparatus; and

FIGS. 32A and 32B are diagrams illustrating Modification 2 of the controller of the post-processing apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below with reference to the drawings. The same reference numerals are given to identical or corresponding constituent elements such as parts and members having the same reference numerals, and redundant descriptions thereof are omitted unless otherwise required.

### Embodiment of Image Forming System

A description is given of an image forming system 1 according to an embodiment of the present disclosure, with reference to the drawings.

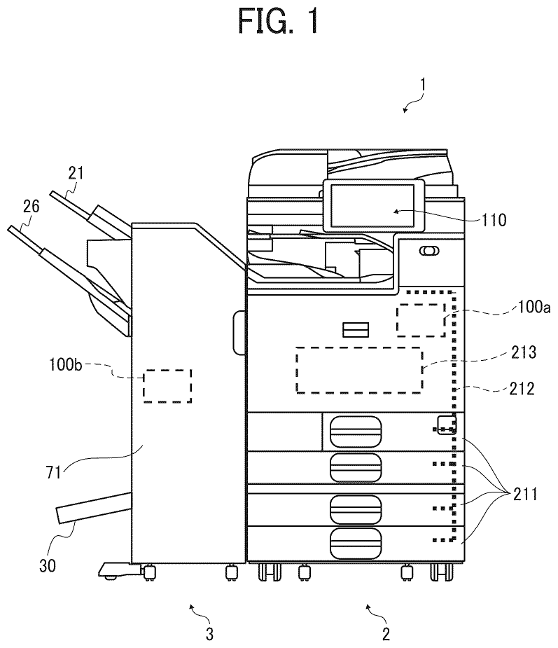

FIG. 1 is a diagram illustrating an overall configuration of the image forming system 1.

The image forming system 1 has a function of forming an image on a sheet P as a sheet medium and a function of performing a post-processing operation on the sheet P as a process after the image is formed on the sheet P. As illustrated in FIG. 1, the image forming system 1 includes an image forming apparatus 2 including the image forming function and a post-processing apparatus 3 serving as a medium processing apparatus including the post-processing function, according to an embodiment of the present disclosure. In the image forming system 1, the image forming apparatus 2 and the post-processing apparatus 3 operate in conjunction with each other.

In the present embodiment, the sheet-shaped medium or sheet-shaped medium to be processed in the image forming system 1 is described on the assumption that the medium is a sheet of “paper”. The object to be processed according to the present embodiment is not limited to a paper. For example, any material or specification may be used as long as an image can be formed on a medium in a known image forming process and the medium is a target of the image forming process. Examples of the medium include a medium that can be an object of a folding process or a binding process, and the material and specification of the medium are not limited to any particular material and specification.

The image forming apparatus 2 forms an image on the sheet P and ejects the sheet P having the image to the post-processing apparatus 3. The image forming apparatus 2 includes a sheet tray 211 that accommodates the sheet P, a conveyor 212 that conveys the sheet P accommodated in the sheet tray 211, and an image former 213 that forms an image on the sheet P conveyed by the conveyor 212. The image former 213 may be an inkjet system that forms an image using ink or an electrophotographic system that forms an image using toner. The image forming apparatus 2 also includes a controller 100a that controls various operations of the conveyor 212 and the image former 213. Since the image forming apparatus 2 has a typical configuration, a detailed description of the configuration is omitted.

Sheets of paper are widely known as an example of sheet-shaped media. In the following description, a sheet-shaped medium as a medium to be processed is referred to as a “sheet P”. In the following description, a bundle of sheets of paper as multiple sheets (media) is an example of a “sheet bundle Pb”.

### First Embodiment of Post-Processing Apparatus

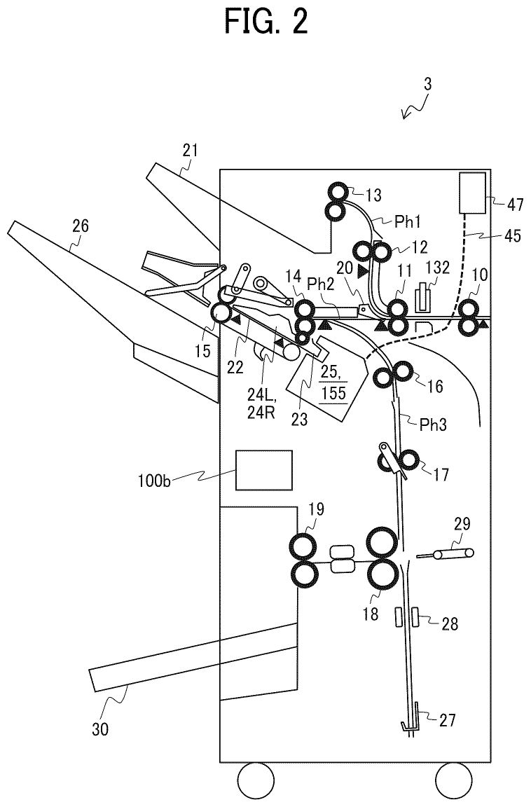

FIG. 2 is a diagram illustrating an internal structure of the post-processing apparatus 3 according to the first embodiment.

The post-processing apparatus 3 has a function that performs post-processing on the sheet P on which an image has been formed by the image forming apparatus 2. An example of the post-processing according to the present embodiment is a binding process as a “crimp binding process” that binds, without a staple, a bundle (sheet bundle) of multiple sheets P on which images have been formed. Another example of the post-processing according to the present embodiment is a binding process as a “stapling process” that binds, with staples, the multiple sheets P on each of which an image is formed as a bundle of sheets (i.e., sheet bundle). In the following description, the bundle of sheets may be referred to as a “sheet bundle Pb” as a bundle of media.

In the present embodiment, a description is given of a liquid application process in a crimp binding process. However, a liquid application process performed in a stapling process is similar to the liquid application process in the crimp binding process. In the following description, the term “binding process” indicates both the “crimp binding process” and the “stapling process”, and is not limited to a binding method (whether a binding needle is used or a pressing and deforming process is performed).

More particularly, the “crimp binding process” according to the present embodiment is a process called “crimp binding” to apply pressure to the binding position corresponding to a part of the sheet bundle Pb to deform (pressure-deform) the binding position and bind the sheet bundle Pb. The binding that can be executed by the post-processing apparatus 3 includes edge binding and saddle binding. The edge binding is a process to bind an end (including an edge) of the sheet bundle Pb. The saddle binding is a process to bind the center of the sheet bundle Pb.

The post-processing apparatus 3 includes conveyance roller pairs 10 to 19 (conveyor), a switching member 20, and a controller 100b (control unit). The controller 100b controls the operations of, for example, the conveyance roller pairs 10 to 19 (conveyor), and the switching member 20. Details of the controller 100b will be described below. The conveyance roller pairs 10 to 19 convey, inside the post-processing apparatus 3, a sheet P supplied from the image forming apparatus 2. More particularly, the conveyance roller pairs 10 to 13 convey the sheet P along a first conveyance passage Ph1. The conveyance roller pairs 14 and 15 convey the sheet P along a second conveyance passage Ph2. The conveyance roller pairs 16 to 19 convey the sheet P along a third conveyance passage Ph3. A hole punch 132 is disposed between the conveyance roller pairs 10 and 11. The hole punch 132 performs punching on a sheet P conveyed by the conveyance roller pairs 10 and 11.

The first conveyance passage Ph1 is a passage extending to a first ejection tray 21 from a supply port through which the sheet P is supplied from the image forming apparatus 2. The second conveyance passage Ph2 is a passage branching from the first conveyance passage Ph1 between the conveyance roller pairs 11 and 14 in the conveyance direction of the sheet and extending to a second ejection tray 26 via the internal tray 22. The third conveyance passage Ph3 is a passage branching from the first conveyance passage Ph1 between the conveyance roller pairs 11 and 14 in the conveyance direction of the sheet and extending to an ejection tray 30.

The switching member 20 is disposed at a branching position of the first conveyance passage Ph1 and the second conveyance passage Ph2. The switching member 20 can be switched between a first position and a second position. The switching member 20 in the first position guides the sheet P to be ejected to the first ejection tray 21 through the first conveyance passage Ph1. The switching member 20 in the second position guides the sheet P conveyed through the first conveyance passage Ph1 to the second conveyance passage Ph2. At the timing when the trailing end of the sheet P entering the second conveyance passage Ph2 passes between the rollers of the conveyance roller pair 11, the conveyance roller pair 14 is rotated in the reverse direction so that the sheet P is guided to the third conveyance passage Ph3. The post-processing apparatus 3 further includes multiple sensors that detect the positions of the sheet P in the first conveyance passage Ph1, the second conveyance passage Ph2, and the third conveyance passage Ph3. Each of the multiple sensors is indicated by a black triangle in FIG. 2.

The post-processing apparatus 3 includes a first ejection tray 21. The sheet P that is output through the first conveyance passage Ph1 is placed on the first ejection tray 21. Among the sheets P supplied from the image forming apparatus 2, a sheet P not subjected to the binding process is ejected to the first ejection tray 21.

The post-processing apparatus 3 further includes the internal tray 22 serving as a placement tray, an edge-binding end fence 23, side fences 24L and 24R, an edge binder 25, a staple binder 155, and a second ejection tray 26. The internal tray 22, the edge-binding end fence 23, the side fences 24L and 24R, the edge binder 25, and the staple binder 155 perform edge binding on the sheet bundle Pb including the multiple sheets P conveyed from the second conveyance passage Ph2 to the internal tray 22. Among the sheets P supplied from the image forming apparatus 2, the sheet bundle Pb subjected to the edge binding is ejected to the second ejection tray 26.

The “edge binding process” here represents a binding process performed by the edge binder 25 and the staple binder 155. Specifically, the “edge binding process” includes, but is not limited to, a “parallel binding process” that binds the sheet bundle Pb along one side of the sheet bundle Pb parallel to the main scanning direction, an “oblique binding process” that binds a corner of the sheet bundle Pb, and a “vertical binding process” that binds the sheet bundle Pb along one side of the sheet bundle Pb parallel to the conveyance direction.

In the following description, a direction in which the sheet P is conveyed from the conveyance roller pair 15 toward the edge-binding end fence 23 is defined as a “conveyance direction”. In other words, the “conveyance direction” in the present specification corresponds to a direction in which the sheet P output from the image forming apparatus 2 is moved toward the second ejection tray 26 by, for example, the conveyance roller pair 10 and is then changed by the conveyance roller pair 15 to move toward the edge-binding end fence 23 as a direction different from the direction toward the second ejection tray 26. A direction that is orthogonal to the conveyance direction and a thickness direction of the sheet P is defined as a “main scanning direction” or a “width direction of the sheet P”.

The sheets P that are sequentially conveyed through the second conveyance passage Ph2 are temporarily placed on the internal tray 22 serving as a placement tray. The edge-binding end fence 23 aligns the position, in the conveyance direction, of the sheet P or the sheet bundle Pb placed on the internal tray 22. The side fences 24L and 24R align the position, in the main scanning direction, of the sheet P or the sheet bundle Pb placed on the internal tray 22. The edge binder 25 and the staple binder 155 perform edge binding on the sheet bundle Pb aligned by the edge-binding end fence 23 and the side fences 24L and 24R.

The conveyance roller pair 15 ejects the sheet bundle Pb subjected to the edge binding to the second ejection tray 26.

The post-processing apparatus 3 further includes a saddle-binding end fence 27, a saddle binder 28, a sheet folding blade 29, and the ejection tray 30. The saddle-binding end fence 27, the saddle binder 28, and the sheet folding blade 29 perform the saddle binding on the sheet bundle Pb of the sheets P that are conveyed through the third conveyance passage Ph3. Among the sheets P supplied from the image forming apparatus 2, the sheet bundle Pb subjected to the saddle binding is ejected to the ejection tray 30.

The saddle-binding end fence 27 aligns the positions, in the conveyance direction, of the multiple sheets P sequentially conveyed through the third conveyance passage Ph3. The saddle-binding end fence 27 can move between a binding position where the saddle-binding end fence 27 causes the center of the sheet bundle Pb to face the saddle binder 28 and a folding position where the saddle-binding end fence 27 causes the center of the sheet bundle Pb to face the sheet folding blade 29. The saddle binder 28 binds the center of the sheet bundle Pb aligned by the saddle-binding end fence 27 at the binding position. The sheet folding blade 29 folds, in half, the sheet bundle Pb placed on the saddle-binding end fence 27 at the folding position and causes the conveyance roller pair 18 to nip the sheet bundle Pb. The conveyance roller pairs 18 and 19 eject the sheet bundle Pb subjected to the saddle binding to the ejection tray 30.

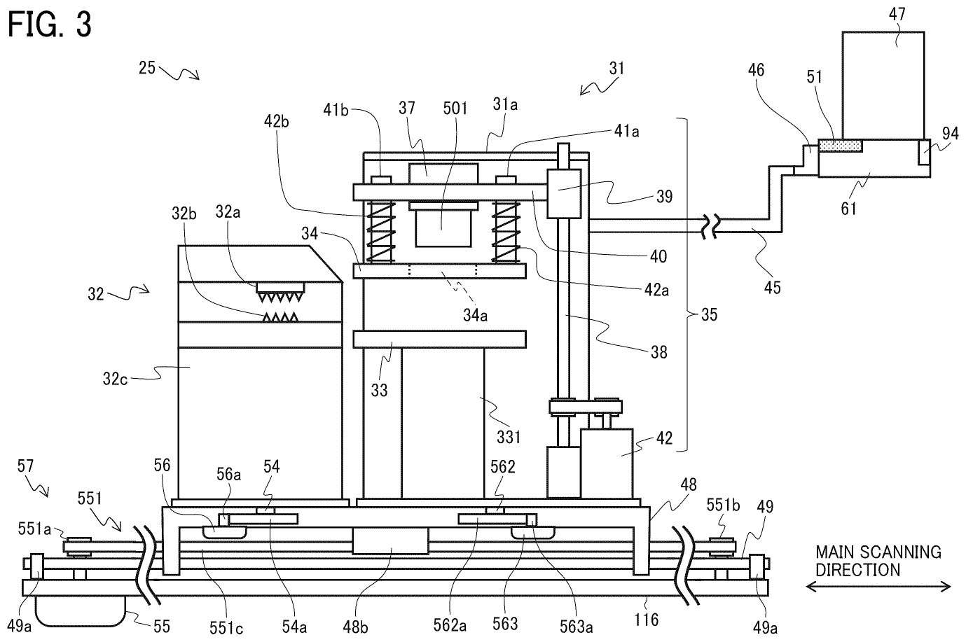

The post-processing apparatus 3 includes a liquid application member 501 (a part of the liquid applier), a liquid supply member 50 (a part of the liquid applier), and a first liquid storage tank 44 (a first liquid storage unit) in the edge binder 25. The first liquid storage tank 44 and the liquid supply member 50 are omitted in FIG. 3. The post-processing apparatus 3 includes a liquid supply passage 45 (a part of a liquid supplier), a liquid supply pump 46 (a part of the liquid supplier), a second liquid storage tank 47 (a part of a second liquid storage), and a second-liquid-storage-tank fixer 61 (a part of the second liquid storage) as a configuration for replenishing the first liquid storage tank 44 with the liquid. The liquid that is stored in the second liquid storage tank 47 is supplied to the first liquid storage tank 44 through the second-liquid-storage-tank fixer 61, the liquid supply pump 46, and the liquid supply passage 45.

### Configuration of Edge Binder

FIG. 3 is a schematic view of the edge binder 25, viewed from the upstream side in the conveyance direction.

The edge binder 25 performs the liquid application process and the crimp binding process illustrated in FIG. 2.

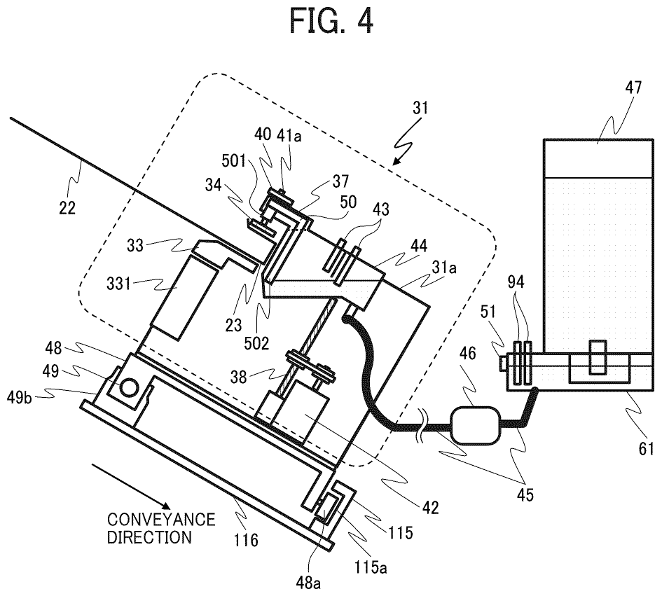

FIG. 4 is a schematic view illustrating a liquid applier 31 of the edge binder 25 when viewed from the main scanning direction.

As illustrated in FIG. 3, the edge binder 25 includes the liquid applier 31 that applies liquid to the sheet P or the sheet bundle Pb, and a crimper 32 that is an example of a post-processing device and performs crimp binding on the sheet bundle Pb. The liquid applier 31 and the crimper 32 are disposed downstream from the internal tray 22 in the conveyance direction and adjacent to each other in the main scanning direction.

As illustrated in FIG. 4, the liquid applier 31 applies the liquid stored in the first liquid storage tank 44 to the sheet P or the sheet bundle Pb placed on the internal tray 22. The application of the liquid to the sheet P or the sheet bundle Pb by the liquid applier 31 and the operation of the liquid applier 31 in applying the liquid are referred to as “liquid application” below. The liquid applying operation of the liquid applier 31 involving control processing is referred to as a “liquid application process”.

More specifically, the liquid that is stored in the first liquid storage tank 44 as liquid for the “liquid application” includes, as a main component, the liquid state of a compound of hydrogen and oxygen compound represented by the chemical formula H2O. The liquid hydrogen-oxygen compound is at any temperature. For example, the liquid hydrogen-oxygen compound may be so-called warm water or hot water. The liquid hydrogen-oxygen compound is not limited to pure water. The liquid hydrogen-oxygen compound may be purified water or may contain ionized salts. The metal ion content ranges from so-called soft water to ultrahard water. In other words, the liquid hydrogen-oxygen compound is at any hardness.

The liquid may include an additive in addition to the main component. The liquid that is stored in the liquid storage tank may include residual chlorine used as tap water. Preferably, for example, the liquid that is stored in the liquid storage tank may include, as an additive, a colorant, a penetrant, a pH adjuster, a preservative such as phenoxyethanol, a drying inhibitor such as glycerin, or a combination thereof. Furthermore, because water is used as a component of ink used for inkjet printers or ink used for water-based pens, such water or ink may be used for the “liquid application”.

The water is not limited to the specific examples described above. The water may be water in a broad sense such as hypochlorous acid water or an ethanol aqueous solution diluted for disinfection. However, tap water may be used simply to enhance the binding strength after the binding process because tap water is easy to obtain and store. A liquid including water as a main component as exemplified above enhances the binding strength of the sheet bundle Pb, in comparison with a liquid of which the main component is not water (liquid).

### Configuration of Liquid Applier

As illustrated in FIGS. 3 and 4, the liquid applier 31 is movable in the main scanning direction together with the crimper 32 by a driving force transmitted from an edge binder movement motor 55. The liquid applier 31 includes a lower pressure plate 33 serving as a receptacle for the sheet P or the sheet bundle Pb, an upper pressure plate 34, and a liquid applier movement assembly 35. The components of the liquid applier 31 (the lower pressure plate 33, the upper pressure plate 34, the liquid applier movement assembly 35, and the liquid applier movement motor 42) are held by the liquid application frame 31a and the base 48.

A liquid applier shaft 562 including a drive transmission gear 562a is fixed to a bottom face of the liquid application frame 31a that holds the components of the liquid applier 31. The liquid applier shaft 562 and the drive transmission gear 562a are held by the base 48 on which the liquid application frame 31a is disposed, so as to be rotatable in the forward and reverse directions. The drive transmission gear 562a meshes with an output gear 563a of a liquid applier pivot motor 563. The liquid applier 31 is rotatable in the forward and reverse directions about the liquid applier shaft 562 on the base 48 by a driving force transmitted from the liquid applier pivot motor 563 to the liquid applier shaft 562 via the output gear 563a and the drive transmission gear 562a.

The lower pressure plate 33 and the upper pressure plate 34 are disposed downstream from the internal tray 22 in the conveyance direction. The sheets P or the sheet bundle Pb that is placed on the internal tray 22 is also placed on the lower pressure plate 33. The lower pressure plate 33 is provided on a lower pressure plate holder 331. The upper pressure plate 34 is movable in the thickness direction of the sheet P or the sheet bundle Pb at a position where the upper pressure plate 34 faces the sheet P or the sheet bundle Pb placed on the internal tray 22.

In other words, the lower pressure plate 33 and the upper pressure plate 34 are disposed to face each other in the thickness direction of the sheet P or the sheet bundle Pb with the sheet P or the sheet bundle Pb placed on the internal tray 22 and interposed between the lower pressure plate 33 and the upper pressure plate 34. In the following description, the thickness direction of the sheet P or the sheet bundle Pb may be referred to simply as “thickness direction”. The upper pressure plate 34 is provided with a through hole 34a passing through the upper pressure plate 34 in the thickness direction at a position opposite to the liquid application member 501 held via a holder 37 attached to a base plate 40. The liquid application member 501 is one end portion of a liquid supply member 50 (liquid absorber) described below and corresponds to a tip portion of the liquid supply member 50.

The liquid applier movement assembly 35 moves the upper pressure plate 34, the base plate 40, the holder 37, the liquid application member 501, the liquid supply member 50, and the first liquid storage tank 44 in the thickness direction of the sheet P or the sheet bundle Pb. The liquid applier movement assembly 35 according to the present embodiment moves the upper pressure plate 34, the base plate 40, the holder 37, the liquid application member 501, the liquid supply member 50, and the first liquid storage tank 44 in conjunction with each other with a single liquid applier movement motor 42. The liquid applier movement assembly 35 includes, for example, a liquid applier movement motor 42, a trapezoidal screw 38, a nut 39, the base plate 40, columns 41a and 41b, and coil springs 42a and 42b.

The liquid applier movement motor 42 generates a driving force to move the upper pressure plate 34, the base plate 40, the holder 37, the liquid application member 501, the liquid supply member 50, and the first liquid storage tank 44. The trapezoidal screw 38 extends in the thickness direction of the sheet P or the sheet bundle Pb and is provided with the liquid application frame 31a such that the trapezoidal screw 38 is rotatable in the forward and reverse directions. The trapezoidal screw 38 is coupled to an output shaft of the liquid applier movement motor 42 via, for example, a pulley and a belt. The nut 39 is screwed to the trapezoidal screw 38. The trapezoidal screw 38 is rotated in the forward and reverse directions by the driving force transmitted from the liquid applier movement motor 42. The rotation of the trapezoidal screw 38 causes the nut 39 to reciprocate on the trapezoidal screw 38.

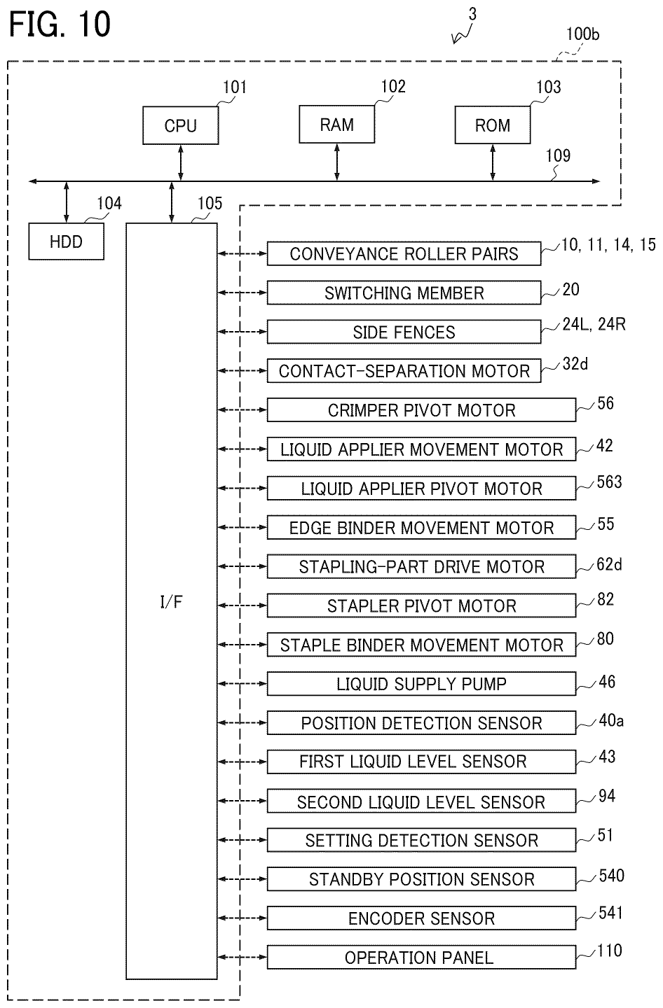

The base plate 40 is positioned apart from the upper pressure plate 34. The base plate 40 holds the liquid application member 501 with the tip portion of the liquid application member 501 protruding from the base plate 40 toward the upper pressure plate 34. The base plate 40 is coupled to the trapezoidal screw 38 via the nut 39 such that base plate 40 can reciprocate along the trapezoidal screw 38 as the trapezoidal screw 38 rotates in the forward and reverse directions. The position of the base plate 40 in the thickness direction of the sheet P or the sheet bundle Pb is detected by a position detection sensor 40a (see FIG. 10).

The columns 41a and 41b project from the base plate 40 toward the upper pressure plate 34 around the tip portion of the liquid application member 501. The columns 41a and 41b can relatively move with respect to the base plate 40 in the thickness direction. The columns 41a and 41b hold the upper pressure plate 34 with the respective tip ends closer to the lower pressure plate 33 than the other ends of the columns 41a and 41b. The other ends of the columns 41a and 41b opposite the ends closer to the lower pressure plate 33 are provided with stoppers that prevent the columns 41a and 41b from being removed from the base plate 40.

The coil springs 42a and 42b are fitted around the columns 41a and 41b, respectively, between the base plate 40 and the upper pressure plate 34. The coil springs 42a and 42b bias the upper pressure plate 34 and the columns 41a and 41b toward the lower pressure plate 33 with respect to the base plate 40.

The liquid applier 31 applies liquid to the sheet P or the sheet bundle Pb placed on the internal tray 22. More particularly, the liquid applier 31 brings the liquid application member 501 into contact with the sheet P or the sheet bundle Pb to apply the liquid to at least one sheet P of the sheet bundle Pb.

The liquid applier 31 includes a first liquid level sensor 43 (a first liquid detector), the first liquid storage tank 44, the liquid application member 501, the liquid supply member 50, and the holder 37. The first liquid storage tank 44 stores the liquid for performing liquid application on the sheet P or the sheet bundle Pb. The liquid stored in the first liquid storage tank 44 is detected by the first liquid level sensor 43. The first liquid storage tank 44 is coupled to the base plate 40 via the holder 37.

The liquid application member 501 applies the liquid stored in the first liquid storage tank 44 to the sheet P or the sheet bundle Pb. The liquid application member 501, the liquid supply member 50 (liquid absorber) disposed in close contact with the liquid application member 501, and the first liquid storage tank 44 are held by the holder 37. The holder 37 is held by the base plate 40. The liquid supply member 50 has a first end in close contact with the liquid application member 501 and a second end immersed in the liquid stored in the first liquid storage tank 44. In other words, the second end of the liquid supply member 50 corresponds to a liquid immersion portion 502 that draws up the liquid and supplies the liquid to the liquid application member 501. The liquid application member 501 and the liquid supply member 50 are made of a material (e.g., sponge or fiber) having a high liquid absorption rate, such as an elastic resin formed of open cells. However, at least one of the liquid application member 501 or the liquid supply member 50 is not limited to a particular type as long as the at least one of the liquid application member 501 or the liquid supply member 50 is made of a material having properties of absorbing and holding the liquid and has a property of being crushable in accordance with a pressing force applied when the at least one of the liquid application member 501 or the liquid supply member 50 is in contact with the sheet P. In other words, the material may be any material as long as the material can absorb or draw up liquid by capillary action.

Accordingly, when the second end (the liquid immersion portion 502) of the liquid supply member 50 is immersed in the liquid stored in the first liquid storage tank 44, the liquid supply member 50 sucks up the liquid by capillary action. In other words, the liquid stored in the first liquid storage tank 44 is sucked up from the liquid immersion portion 502 of the liquid supply member 50, and the sucked liquid is supplied to the liquid application member 501 that is coupled to the tip portion via the liquid supply member 50. Then, the liquid stored in the first liquid storage tank 44 is sucked up to the liquid application member 501 in close contact with one end portion of the liquid supply member 50, and thus the liquid level (stored liquid amount) of the liquid stored in the first liquid storage tank 44 detected by the first liquid level sensor 43 is lowered. As a result, the liquid is supplied from the second liquid storage tank 47 to the first liquid storage tank 44 by the liquid supply pump 46.

Although the case where the liquid supply member 50 and the liquid application member 501 are separate bodies has been described above, the liquid supply member 50 and the liquid application member 501 may be integrally formed of a material having the same properties (for example, a material having a high liquid absorption rate). In other words, the liquid application member 501 may be part of the liquid supply member 50. In such a case, liquid can be supplied from the liquid supply member 50 to the liquid application member 501 more smoothly by the capillary action and a reduction in cost can be achieved.

At this time, the liquid application member 501 draws up the liquid stored in the first liquid storage tank 44. By so doing, the amount of liquid (liquid level) in the first liquid storage tank 44 temporarily decreases to the level below the reference liquid level described below. In response to this decrease of liquid in the first liquid storage tank 44, a series of liquid supply operations for feeding liquid from the second liquid storage tank 47 to the first liquid storage tank 44 is performed. This series of liquid supply operations is mainly performed at the time of activation of the post-processing apparatus 3 or at the time of start of execution of the binding process involving liquid application in the post-processing apparatus 3, and corresponds to the liquid supply operations for bringing the liquid application using the liquid application member 501 to be executable.

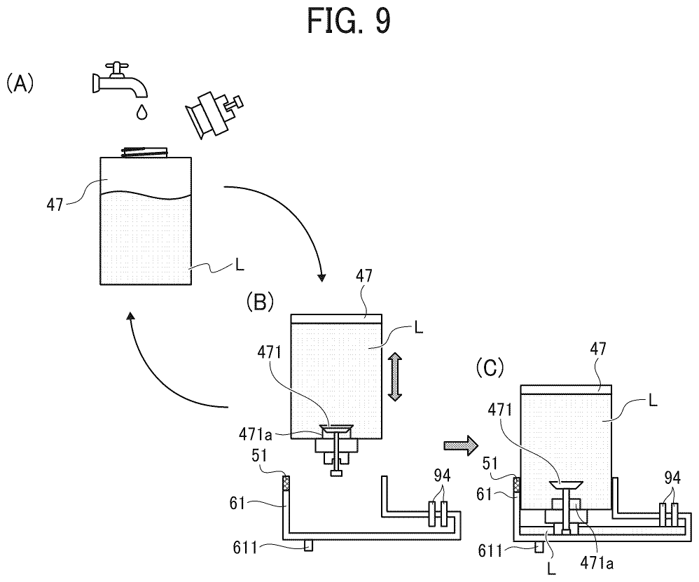

The edge binder 25 or the post-processing apparatus 3 is provided with the second liquid storage tank 47. The second liquid storage tank 47 is attachable to and detachable from the second-liquid-storage-tank fixer 61 (a part of the second liquid storage) disposed in the edge binder 25 or the post-processing apparatus 3 (see FIG. 9, specifically, parts FIGS. 9(A) to 9(C)). When the second liquid storage tank 47 is fixed (set) to the second-liquid-storage-tank fixer 61 (a part of the second liquid storage) in a given position, the liquid already stored in the second liquid storage tank 47 can be supplied to the first liquid storage tank 44.

The operation to supply liquid from the second liquid storage tank 47 to the first liquid storage tank 44 by the liquid supply pump 46 is executed in response to a decrease in the stored liquid amount (liquid level) in the first liquid storage tank 44. The stored liquid amount (liquid level) of the first liquid storage tank 44 is reduced by the liquid being consumed by the liquid application by the liquid applier 31. In other words, the operation of supplying liquid from the second liquid storage tank 47 to the first liquid storage tank 44 corresponds to the liquid supply operation needed with the execution of the job including the liquid application by the liquid applier 31.

This liquid supply operation corresponds to an operation of supplying liquid to the first liquid storage tank 44 so as to add liquid each time the stored liquid amount (liquid level) of the first liquid storage tank 44 falls below the reference liquid level, which is described below.

When the second liquid storage tank 47 is set in the second-liquid-storage-tank fixer 61, the second-liquid-storage-tank fixer 61 is filled with a certain amount of the liquid in the second liquid storage tank 47. The second-liquid-storage-tank fixer 61 includes a setting detection sensor 51 (a setting detector) (see FIG. 9, specifically, part FIG. 9(B)). When the setting detection sensor 51 detects the set state of the second liquid storage tank 47 to the second-liquid-storage-tank fixer 61 (see FIG. 9, specifically, part FIG. 9(C)), a signal indicating the set state is transmitted to the controller 100b, which is described below. Thus, the controller 100b detects whether the second liquid storage tank 47 is set on the second-liquid-storage-tank fixer 61. Details of the second liquid storage tank 47 are described later.

The first liquid storage tank 44 and the second liquid storage tank 47 are coupled to each other by the liquid supply passage 45. The liquid supply pump 46 is disposed near the second-liquid-storage-tank fixer 61. As the liquid supply pump 46 is driven, the liquid stored in the second liquid storage tank 47 is supplied (replenished) from the second liquid storage tank 47 to the first liquid storage tank 44 via the liquid supply passage 45. Accordingly, the second-liquid-storage-tank fixer 61 is a component of the liquid supplier that executes a liquid supply operation to supply liquid from the second liquid storage tank 47 to the first liquid storage tank 44. The liquid supply passage 45 includes a flexible material. According to such a configuration, even if the first liquid storage tank 44 is moved by the liquid applier movement assembly 35, liquid can be supplied from the second liquid storage tank 47 to the first liquid storage tank 44.

The amount of liquid supplied from the second liquid storage tank 47 to the first liquid storage tank 44 can be controlled in accordance with the detection result of the first liquid level sensor 43. In other words, the controller 100b, which is described below, determines whether the stored liquid amount (liquid level) in the first liquid storage tank 44 based on the detection result of the first liquid level sensor 43. In accordance with the determined stored liquid amount (liquid level) of the first liquid storage tank 44, the controller 100b controls the operation speed and time of the liquid supply pump 46. Thus, the controller 100b can adjust the amount of liquid to be replenished to the first liquid storage tank 44 to maintain the stored liquid amount (liquid level) in the first liquid storage tank 44 at a constant level of liquid.

### Configuration of Crimper

As illustrated in FIG. 3, the crimper 32 as a post-processing device presses and deforms at least a portion (in other words, liquid application position) of the sheet bundle Pb, to which liquid has been applied by the liquid applier 31, by serrated upper crimping teeth 32a and lower crimping teeth 32b, and crimps the sheets P of the portion to bind the sheet bundle Pb. In other words, the crimper 32 can bind the sheet bundle Pb without using staples. The components of the crimper 32 such as the upper crimping teeth 32a and the lower crimping teeth 32b are disposed on a crimping frame 32c. Hereinafter, binding by pressing and deforming a given position of the sheet bundle Pb by the crimper 32 will be simply referred to as “crimp binding”. The crimping and binding process of the crimper 32 that involves control processing is referred to as “crimp binding process”.

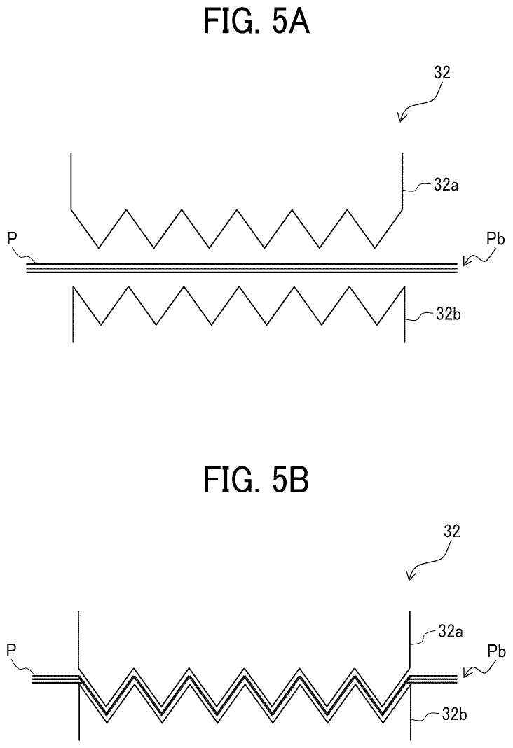

FIGS. 5A and 5B are schematic views illustrating the configuration of the crimper 32.

As illustrated in FIGS. 5A and 5B, the crimper 32 includes the upper crimping teeth 32a and the lower crimping teeth 32b. The upper crimping teeth 32a and the lower crimping teeth 32b are disposed to face each other in the thickness direction of the sheet bundle Pb to sandwich the sheet bundle Pb placed on the internal tray 22. The upper crimping teeth 32a and the lower crimping teeth 32b have respective serrate faces facing each other. The serrate face of each of the upper crimping teeth 32a and the lower crimping teeth 32b includes concave portions and convex portions alternately formed. The concave portions and the convex portions of the upper crimping teeth 32a are shifted from those of the lower crimping teeth 32b such that the upper crimping teeth 32a are engaged with the lower crimping teeth 32b. The upper crimping teeth 32a and the lower crimping teeth 32b are brought into contact with and separated from each other by the driving force of a contact-separation motor 32d (see FIG. 10).

In the process of supplying the multiple sheets P of the sheet bundle Pb to the internal tray 22, the upper crimping teeth 32a and the lower crimping teeth 32b are separated from each other as illustrated in FIG. 5A. When all the sheets P of the sheet bundle Pb are placed on the internal tray 22, the upper crimping teeth 32a and the lower crimping teeth 32b are engaged with each other as illustrated in FIG. 5B by the driving force of the contact-separation motor 32d to press and deform the sheet bundle Pb in the thickness direction. As a result, the sheet bundle Pb that has been placed on the internal tray 22 is crimped and bound. The sheet bundle Pb thus crimped and bound is ejected to the second ejection tray 26 by the conveyance roller pair 15.

The configuration of the crimper 32 as a crimping assembly is not limited to the configuration of a moving assembly exemplified in the present embodiment, and may be any other suitable structure in which the upper crimping teeth 32a and the lower crimping teeth 32b of the crimping assembly engage with each other. For example, the crimping assembly may bring the upper crimping teeth 32a and the lower crimping teeth 32b into contact with each other and separate the upper crimping teeth 32a and the lower crimping teeth 32b from each other with a link mechanism and a driving source that simply rotates in the forward direction or that rotates the forward and backward directions (e.g., the crimping assembly disclosed in Japanese Patent No. 6057167). The crimping assembly may employ a linear motion system to linearly bring the upper crimping teeth 32a and the lower crimping teeth 32b into contact with each other and separate the upper crimping teeth 32a and the lower crimping teeth 32b from each other with a screw assembly that converts the forward and backward rotational motions of a driving source into linear reciprocating motion.

As illustrated in FIG. 3, the edge binder 25 includes an edge binder movement assembly 57. The edge binder movement assembly 57 moves the edge binder 25 (in other words, the liquid applier 31 and the crimper 32) in the main scanning direction along the downstream end of the sheet P, which is placed on the internal tray 22, in the conveyance direction. The edge binder movement assembly 57 includes, for example, the base 48, a guide shaft 49, the edge binder movement motor 55, and a driving force transmission assembly 551 that transmits the driving force of the edge binder movement motor 55 to the base 48, and a standby position sensor 540 (see FIG. 10).

The liquid applier 31 and the crimper 32 are attached to the base 48 such that the liquid applier 31 and the crimper 32 are adjacent to each other in the main scanning direction. As illustrated in FIGS. 3 and 4, the guide shaft 49 is disposed in the main scanning direction on the upstream side of a binding assembly base 116 in the conveyance direction and is held by multiple guide shaft brackets 49a and 49b. As illustrated in FIG. 3, the guide shaft 49 is disposed to extend in the main scanning direction on the binding assembly base 116, and holds the base 48 to be movable in the main scanning direction. As illustrated in FIG. 4, the guide rail 115 is disposed in the downstream side of the binding assembly base 116 in the conveyance direction and extends in the main scanning direction. The guide rail 115 has a to-be-fitted portion 115a that fits a scanning roller 48a, which is rotatably disposed on the base 48, across the main scanning direction. In other words, the base 48 is movably held by the guide shaft 49 and the guide rail 115 in the main scanning direction on the binding assembly base 116.

The edge binder movement motor 55 generates a driving force to move the edge binder 25. The driving force transmission assembly 551 transmits the driving force of the edge binder movement motor 55 to the base 48 via pulleys 551a and 551b, a timing belt 551c, and a fastening portion 48b that fastens the base 48 and the timing belt 551c. As a result, the liquid applier 31 and the crimper 32 integrated by the base 48 move in the main scanning direction along the guide shaft 49.

The edge binder movement motor 55 according to the present embodiment is, for example, a servo motor that can stop the edge binder 25 at a target position (the first binding position B1 described below) without returning the edge binder 25 to an origin position (for example, a standby position HP described below) each time the edge binder 25 moves.

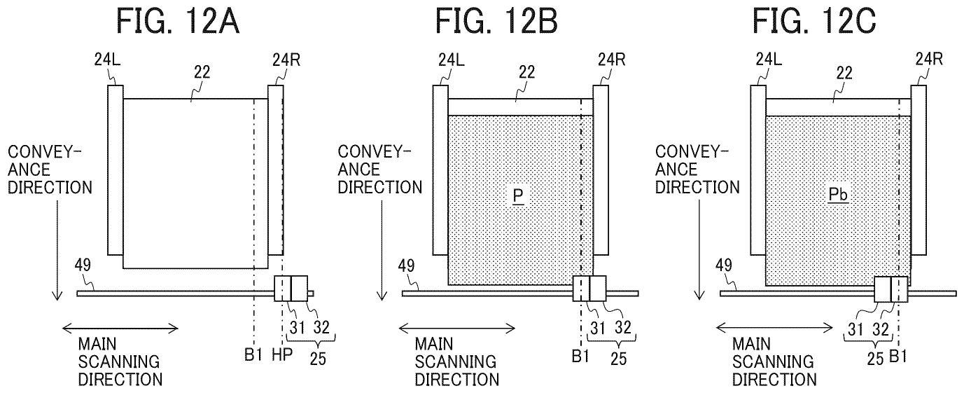

The post-processing apparatus 3 further includes a standby position sensor 540 (for example, a light shielding optical sensor, see FIG. 10) that detects that the edge binder 25 has reached the standby position HP (see part FIG. 12A), and an encoder sensor 541 (see FIG. 10) attached to an output shaft of the edge binder movement motor 55. The controller 100b, which is described below, detects that the edge binder 25 has reached the standby position HP, based on a detection result of the standby position sensor 540. The controller 100b also counts pulse signals output from the encoder sensor 541 to ascertain the current position of the edge binder 25 moved from the standby position HP.

However, a specific method of stopping the edge binder 25 at the target position without returning the edge binder 25 to the standby position HP is not limited to the aforementioned example. As another example, the post-processing apparatus 3 may include a sensor that detects that the edge binder 25 has reached a predetermined target position.

As illustrated in FIG. 3, a crimper shaft 54 provided with a drive transmission gear 54a is fixed to a bottom face of the crimping frame 32c that holds the components of the crimper 32. The crimper shaft 54 and the drive transmission gear 54a are held by the base 48 on which the crimping frame 32c is disposed, so as to be rotatable in the forward and reverse directions. The drive transmission gear 54a meshes with an output gear 56a of a crimper pivot motor 56. The crimper 32 is rotatable in the forward and reverse directions about the crimper shaft 54 on the base 48 by a driving force transmitted from the crimper pivot motor 56 to the crimper shaft 54 via the output gear 56a and the drive transmission gear 54a.

In the above description, the edge binder 25 has a configuration of moving along the guide shaft 49 with the crimper 32 and the liquid applier 31 being integrated, the embodiments of the present disclosure are not limited to the above-described configuration. For example, the crimper 32 and the liquid applier 31 may have a configuration of moving separately from each other.

### Configuration of Staple Binder

Specifically, a detailed description is now given of the staple binder 155 having a function of executing a stapling process.

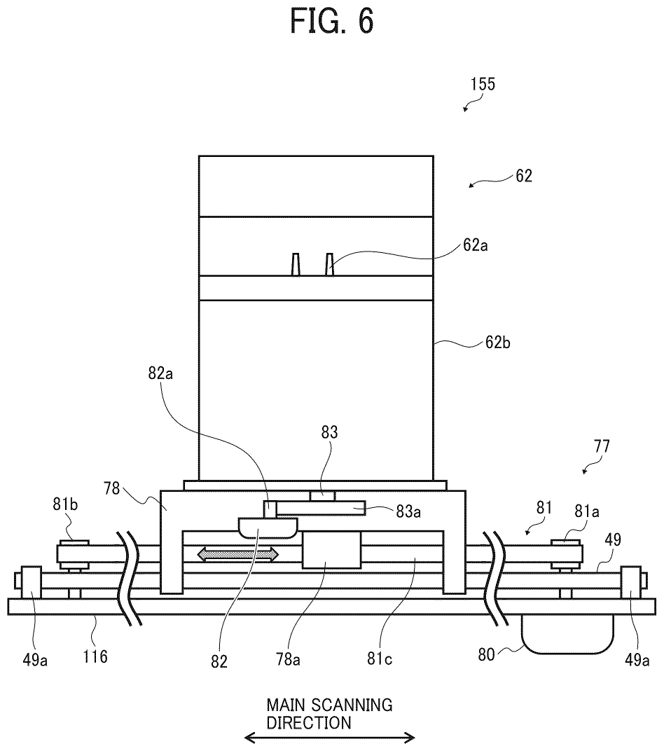

FIG. 6 is a schematic view of the staple binder 155 as viewed from the upstream side in the conveyance direction.

The staple binder 155 includes a stapler 62 that binds the sheet bundle Pb with staples. The stapler 62 is disposed downstream from the internal tray 22 in the conveyance direction and spaced apart from the edge binder 25 in the main scanning direction.

The stapler 62 serving as a post-processing device has a configuration of performing so-called “stapling process” to bind the sheet bundle Pb with a staple. More particularly, the stapler 62 includes a stapling-part drive motor 62d (see FIG. 10). The stapling-part drive motor 62d drives a stapling part 62a. The driving force of the stapling-part drive motor 62d causes a staple loaded in the stapling part 62a to insert through a sheet bundle Pb, so that the stapling part 62a binds the sheet bundle Pb. Since the stapler 62 has a typical configuration, a detailed description thereof will be omitted.

As illustrated in FIG. 6, the staple binder 155 includes a staple binder movement assembly 77. The staple binder movement assembly 77 moves the staple binder 155 in the main scanning direction along a downstream end in the conveyance direction of the sheet P or the sheet bundle Pb placed on the internal tray 22. The staple binder movement assembly 77 includes, for example, a base 78, the guide shaft 49, a staple binder movement motor 80, and a driving force transmission assembly 81. The driving force transmission assembly 81 transmits a driving force of the staple binder movement motor 80 to the base 78 via pulleys 81a and 81b, a timing belt 81c, and a fastening portion 78a that fastens the base 78 and the timing belt 81c. A stapler shaft 83 including a drive transmission gear 83a is fixed to a bottom face of a stapling frame 62b that holds the components of the stapler 62.

The stapler shaft 83 and the drive transmission gear 83a are held by the base 78 on which the stapling frame 62b is disposed, so as to be rotatable in the forward and reverse directions. The drive transmission gear 83a meshes with an output gear 82a of a stapler pivot motor 82. The stapler 62 is rotatable in the forward and reverse directions about the stapler shaft 83 on the base 78 by a driving force transmitted from the stapler pivot motor 82 to the stapler shaft 83 via the output gear 82a and the drive transmission gear 83a.

The edge binder 25 and the staple binder 155 are supported by the common guide shaft 49. In other words, the edge binder movement assembly 57 and the staple binder movement assembly 77 move the edge binder 25 and the staple binder 155 in the main scanning direction along the common guide shaft 49. The edge binder movement assembly 57 and the staple binder movement assembly 77 can independently move the edge binder 25 and the staple binder 155.

### Configuration of Modification of Staple Binder

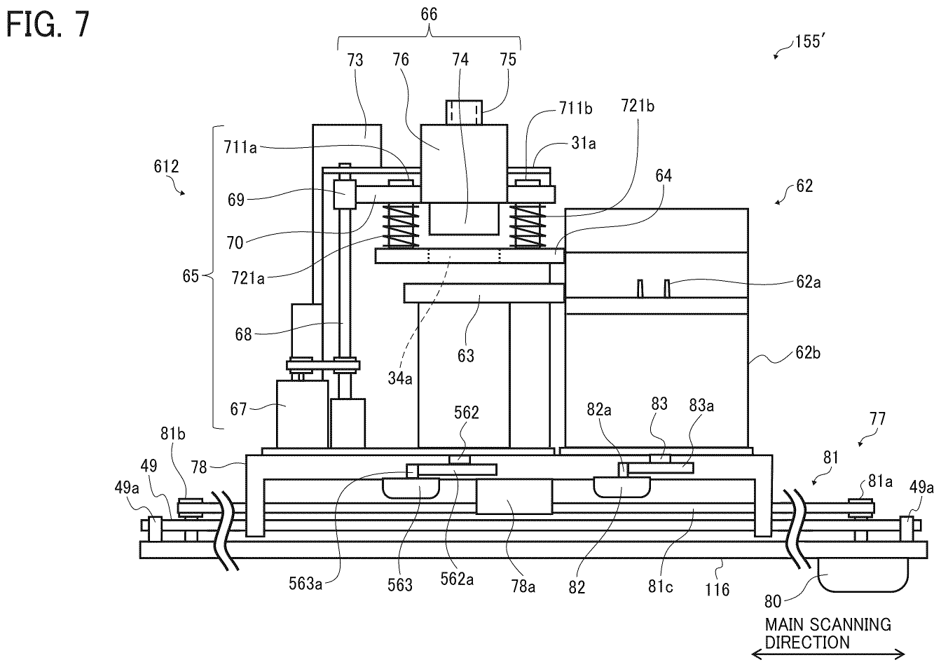

FIG. 7 illustrates a staple binder 155′ as a modification of the staple binder 155, and is a schematic view of the staple binder 155′ as viewed from the upstream side in the conveyance direction. The staple binder 155′ is different from the staple binder 155 in that the staple binder 155′ includes a second liquid applier 612 in addition to the stapler 62. As illustrated in FIG. 7, the staple binder 155′ includes the second liquid applier 612 and the stapler 62. The second liquid applier 612 and the stapler 62 are disposed downstream from the internal tray 22 in the conveyance direction and adjacent to each other in the main scanning direction.

The second liquid applier 612 performs the liquid application of applying liquid stored in a third liquid storage tank 73 to the sheet P or the sheet bundle Pb placed on the internal tray 22. A given area including a position to which the liquid application is performed on the sheet P or the sheet bundle Pb by the second liquid applier 612 corresponds to a binding position to be stapled by the stapler 62. As illustrated in FIG. 7, the second liquid applier 612 includes a second lower pressure plate 63, a second upper pressure plate 64, a second liquid-application-unit movement assembly 65, and a second liquid application assembly 66. The liquid-application-unit movement assembly 65 includes, for example, a second liquid applier movement motor 67, a second trapezoidal screw 68, a second nut 69, a second base plate 70, second columns 711a and 711b, and second coil springs 721a and 721b.

The second liquid application assembly 66 includes the third liquid storage tank 73, a second liquid supply member 75, a second liquid application member 74, and a second joint 76. Since the second liquid application assembly 66 and the liquid application assembly of the liquid applier 31 (including the first liquid storage tank 44, the liquid supply member 50, the liquid application member 501, and the holder 37) illustrated in FIGS. 3 and 4 have common configurations, redundant descriptions thereof will be omitted. Since the stapler 62 has a configuration similar to the configuration of the staple binder 155 illustrated in FIG. 6, a detailed description thereof is omitted below. Since the second liquid applier 612 and the liquid applier 31 that are illustrated in FIG. 3 have common pivot mechanisms, redundant descriptions thereof will be omitted. The pivot mechanism of the second liquid applier 612 includes the liquid applier pivot motor 563, the output gear 563a, the drive transmission gear 562a, and the liquid applier shaft 562.

As with the staple binder 155′ illustrated in FIG. 7, when the liquid application is also performed on the sheet P in the stapling process, the binding position is loosened and softened, thus allowing the staple to easily pass through. As a result, the number of sheets to be bound per sheet bundle Pb can be increased as compared with a case where the stapling process is performed without applying the liquid.

### Configuration of Second Liquid Storage Tank

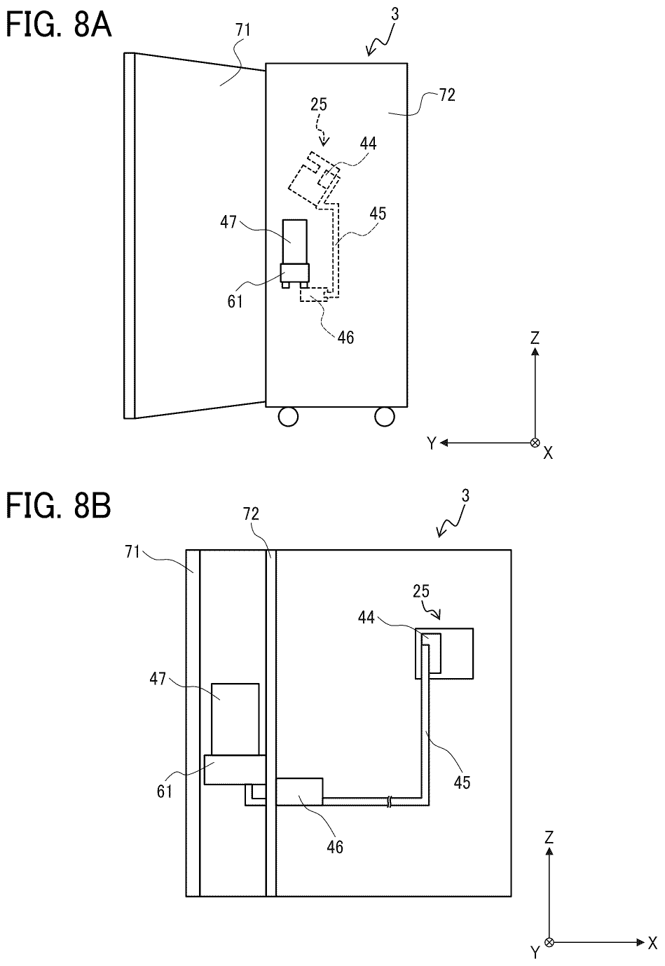

With reference to FIGS. 8A, 8B, and 9, a description is given of the arrangement and configuration of the second liquid storage tank 47 in the post-processing apparatus 3.

FIGS. 8A and 8B illustrate an example arrangement and configuration of the second liquid storage tank 47 as the main tank.

FIG. 8A illustrates the post-processing apparatus 3 with a cover 71 opened.

FIG. 8B is a cross-sectional side view of the post-processing apparatus 3, illustrating the post-processing apparatus 3 with the cover 71 closed.

As illustrated in FIG. 8A, the second liquid storage tank 47 is located so as to be accessible when the cover 71 of the post-processing apparatus 3 is opened. As illustrated in FIG. 8B, the second liquid storage tank 47 and the second-liquid-storage-tank fixer 61 are disposed on the near side in a depth direction (X direction) of the post-processing apparatus 3. The first liquid storage tank 44 is disposed on the far side in the depth direction (X direction) of the post-processing apparatus 3. A housing side plate 72 of the post-processing apparatus 3 is disposed between the location of the second liquid storage tank 47 and the second-liquid-storage-tank fixer 61 and the location of the first liquid storage tank 44 and so forth. The second-liquid-storage-tank fixer 61 is attached to the housing side plate 72 of the post-processing apparatus 3.

FIG. 9 including parts FIGS. 9(A), 9(B) and 9(C) is a diagram illustrating a state in which the second liquid storage tank 47 is attachable to and detachable from the second-liquid-storage-tank fixer 61 and a state in which liquid Lis replenished to the second liquid storage tank 47.

As illustrated in part FIG. 9(A) of FIG. 9, the second liquid storage tank 47 is attachable to and detachable from the second-liquid-storage-tank fixer 61 so that liquid L can be replenished to the first liquid storage tank 44. As illustrated in part FIG. 9(B) of FIG. 9, the second-liquid-storage-tank fixer 61 is provided with the setting detection sensor 51 serving as a setting detector that detects that the second liquid storage tank 47 is set on the second-liquid-storage-tank fixer 61.

When the setting detection sensor 51 detects the set state of the second liquid storage tank 47 to the second-liquid-storage-tank fixer 61 (see part FIG. 9(C) of FIG. 9), a signal indicating the set state is transmitted to the controller 100b, which is described below. Thus, the controller 100b detects whether the second liquid storage tank 47 is set on the second-liquid-storage-tank fixer 61.

The second liquid-level sensor 94 (a second liquid detector) that detects the amount of liquid L stored in the second liquid storage tank 47 is disposed in the second-liquid-storage-tank fixer 61. The output value (voltage) of the second liquid-level sensor 94 is notified to the controller 100b. The controller 100b determines the output value (voltage) of the second liquid-level sensor 94 to determine whether the amount of liquid stored in the second-liquid-storage-tank fixer 61 is a required amount of liquid. When determining that the second liquid storage tank 47 is in the set state according to the output signal of the setting detection sensor 51, the controller 100b described later turns on the second liquid-level sensor 94 to make it possible to detect the presence or absence (liquid level) of the liquid in the second-liquid-storage-tank fixer 61.

When the second liquid storage tank 47 is not set on the second-liquid-storage-tank fixer 61 (i.e., is in a non-set state), a liquid discharge port 471a of the second liquid storage tank 47 is closed by a liquid supply valve 471 so that liquid L does not leak. As illustrated in part FIG. 9(C) of FIG. 9, when the second liquid storage tank 47 is set to the second-liquid-storage-tank fixer 61, the liquid supply valve 471 is pushed up to open the liquid discharge port 471a of the second liquid storage tank 47. Thus, the liquid L can flow out from the second liquid storage tank 47 to the second-liquid-storage-tank fixer 61. As a result, the liquid L stored in the second liquid storage tank 47 flows out to the second-liquid-storage-tank fixer 61. The liquid L that has flowed out from the second liquid storage tank 47 is stored in the second-liquid-storage-tank fixer 61.

As a measurement to prevent liquid L from being frozen during maintenance of the post-processing apparatus 3, a liquid draining process may be performed to drain the liquid L in the post-processing apparatus 3. In the liquid draining process, the liquid L remaining in the first liquid storage tank 44 and the liquid supply passage 45 is supplied by the liquid supply pump 46 to the second-liquid-storage-tank fixer 61 via the liquid supply passage 45 in the reverse direction. For that purpose, the second-liquid-storage-tank fixer 61 is set to the capacity that can sufficiently store liquid L in the first liquid storage tank 44 and the liquid supply passage 45. As illustrated in parts FIG. 9(B) and FIG. 9(C) of FIG. 9, the second-liquid-storage-tank fixer 61 is provided with a liquid drain plug 611. After the liquid L remaining in the first liquid storage tank 44 and the liquid supply passage 45 is reversely fed by the liquid supply pump 46 to the second-liquid-storage-tank fixer 61, the liquid drain plug 611 is opened to drain the liquid stored in the second-liquid-storage-tank fixer 61 from the inside of the post-processing apparatus 3.

### Configuration of Control Block of Post-Processing Apparatus

A description is given below of a configuration of a control block of the post-processing apparatus 3, with reference to FIG. 10.

FIG. 10 is a hardware configuration diagram for executing control process in the post-processing apparatus 3 according to the first embodiment.

As illustrated in FIG. 10, the post-processing apparatus 3 includes a central processing unit (CPU) 101, a random access memory (RAM) 102, a read-only memory (ROM) 103, a hard disk drive (HDD) 104, and an interface (I/F) 105. The CPU 101, the RAM 102, the ROM 103, the HDD 104, and the I/F 105 are connected to each other via a common bus 109.

The CPU 101 is an arithmetic unit and controls the overall operation of the post-processing apparatus 3.

The RAM 102 is a volatile storage medium that allows data to be read and written at high speed. The CPU 101 uses the RAM 102 as a working area for data processing.

The ROM 103 is a read-only non-volatile storage medium that stores programs such as firmware.

The HDD 104 is a non-volatile storage medium that allows data to be read and written and has a relatively large storage capacity. The HDD 104 stores, e.g., an operating system (OS), various control programs, and application programs.

By an arithmetic function of the CPU 101, the post-processing apparatus 3 processes, for example, a control program stored in the ROM 103 and an information processing program (application program) loaded into the RAM 102 from a storage medium such as the HDD 104. Such processing configures a software controller including various functional modules of the post-processing apparatus 3. The software controller thus configured cooperates with hardware resources of the post-processing apparatus 3 to construct functional blocks that implement functions of the post-processing apparatus 3. In other words, the CPU 101, the RAM 102, the ROM 103, the HDD 104, and the I/F 105 form at least part of a controller 100b (control unit) that controls the operation of the post-processing apparatus 3.

The I/F 105 is an interface that connects the conveyance roller pairs 10, 11, 14, and 15, the switching member 20, the side fences 24L and 24R, the contact-separation motor 32d, the crimper pivot motor 56, the liquid applier movement motor 42, the liquid applier pivot motor 563, the edge binder movement motor 55, the stapling-part drive motor 62d, the stapler pivot motor 82, the staple binder movement motor 80, the liquid supply pump 46, the position detection sensor 40a, the first liquid level sensor 43, the second liquid-level sensor 94, the setting detection sensor 51, the standby position sensor 540, the encoder sensor 541, and an operation panel 110 to the common bus 109.

The controller 100b controls, via the I/F 105, the operations of the conveyance roller pairs 10, 11, 14, and 15, the switching member 20, the side fences 24L and 24R, the contact-separation motor 32d, the crimper pivot motor 56, the liquid applier movement motor 42, the liquid applier pivot motor 563, the edge binder movement motor 55, the stapling-part drive motor 62d, the stapler pivot motor 82, the staple binder movement motor 80, and the liquid supply pump 46. The controller 100b acquires detection results from the position detection sensor 40a, the first liquid level sensor 43, the second liquid-level sensor 94, the setting detection sensor 51, the standby position sensor 540, and the encoder sensor 541. Although FIG. 10 illustrates the components related to the edge binder 25 and the staple binder 155 that perform the edge binding, the components related to the saddle binder 28 that performs the saddle binding are also controlled by the controller 100b.

As illustrated in FIG. 1, the image forming apparatus 2 includes the operation panel 110. The operation panel 110 includes an operation unit that receives instructions input by a user and a display serving as a notifier that notifies the user of information. The operation unit includes, for example, physical input buttons and a touch screen overlaid on a display. The operation panel 110 acquires information from the user through the operation unit and provides information to the user through the display. A specific example of the notification unit is not limited to the display and may be a light emitting diode (LED) lamp or a speaker. The post-processing apparatus 3 may include the operation panel 110 similar to the above-described operation panel 110 of the image forming apparatus 2.

As described above, the post-processing apparatus 3 implements the function of performing operation control related to the liquid application by software (control programs) executed by the CPU 101 with hardware resources included in the controller 100b.

In some embodiments, the liquid application performed by the post-processing apparatus 3 may be performed in a form in which the staple binder 155 is provided with only the stapler 62 and the liquid application is performed using the liquid applier 31 of the edge binder 25. By contrast, the edge binder 25 may include only the crimper 32, and the liquid application may be performed in a mode in which the second liquid applier 612 is used. In other words, the post-processing apparatus 3 may have a configuration in which only one of the liquid applier 31 and the second liquid applier 612 performs the liquid application, regardless of the type of the binding process.

In the above description, the staple binder 155′ has a configuration of moving along the guide shaft 49 with the stapler 62 and the second liquid applier 612 being integrated, the embodiments of the present disclosure are not limited to the above-described configuration. For example, the stapler 62 and the second liquid applier 612 may have a configuration of moving separately from each other.

### Description of Binding Process

A description is given below of the binding process executed by the edge binder 25 included in the post-processing apparatus 3.

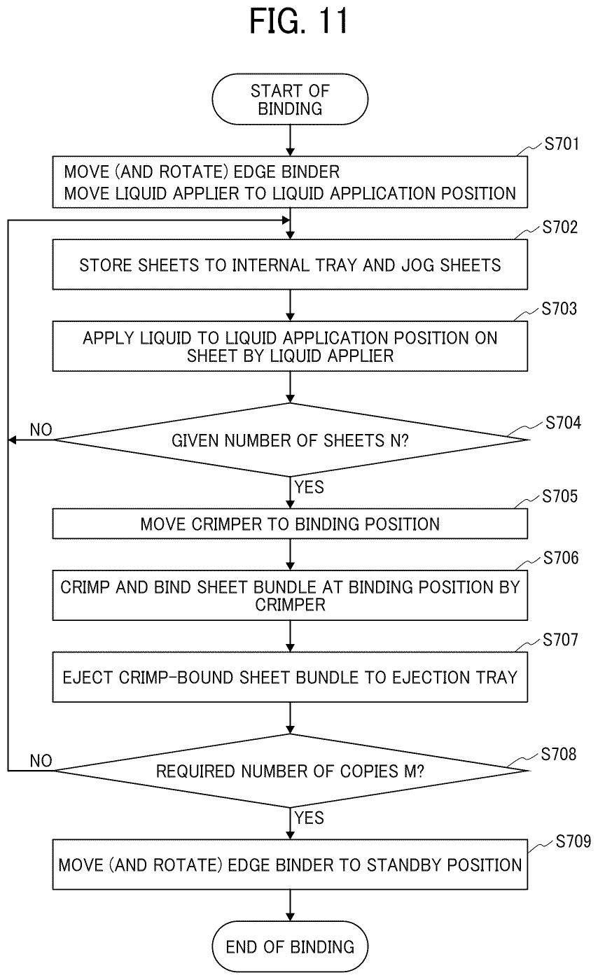

FIG. 11 is a flowchart of a process of executing one-point binding.

FIGS. 12A, 12B, and 12C are diagrams illustrating the position shift of the edge binder 25 (the liquid applier 31 and the crimper 32) during the one-point binding.

In FIGS. 12A, 12B, and 12C, the changes in the postures of the liquid applier 31 and the crimper 32 are omitted. The position (liquid application position) at which liquid application is executed on the sheet P or the sheet bundle Pb by the liquid applier 31 corresponds to the binding position on the sheet bundle Pb to be crimped and bound by the crimper 32. For this reason, in the following description, the liquid application position and the binding position are denoted by the same reference sign (B1).

For example, the controller 100b starts the binding process illustrated in FIG. 11 when the controller 100b acquires an instruction to execute the binding process from the image forming apparatus 2. In the following description, the instruction to execute the binding process may be referred to as a “binding command”.

The binding command includes, for example, the type of the sheet P (i.e., information affecting the spread of liquid, such as material and thickness), the number of sheets P of the sheet bundle Pb, the number of sheet bundles Pb to be bound, the binding position on the sheet bundle Pb, and the binding posture of the edge binder 25. In the following description, the number of sheets P of the sheet bundle Pb may be referred to as “given number of sheets N” whereas the number of sheet bundles Pb to be bound may be referred to as “requested number of copies M”. The liquid applier 31 and the crimper 32 are assumed to be in a parallel binding posture and located at a standby position HP that is a position away in the width direction from the sheets P placed on the internal tray 22 at the start of the binding process as illustrated in FIG. 12A.

When the posture that is instructed by the binding command is the “inclined binding posture”, the controller 100b drives the liquid applier pivot motor 563 and the crimper pivot motor 56 to rotate the liquid applier 31 and the crimper 32 of the edge binder 25 into the inclined binding posture (step S701). When the posture that is instructed by the binding command is the “inclined binding posture”, the crimper 32 alone may be rotated to the inclined binding posture while the liquid applier 31 may not be rotated. As a result, the driving assembly may be simplified as compared with a case where both the liquid applier 31 and the crimper 32 are rotated in the forward and reverse directions, and thus effects of cost reduction, downsizing of the apparatus, and reduction of failure of the device are exhibited. On the other hand, when the posture that is instructed by the binding command is the “parallel binding posture”, the controller 100b omits the aforementioned operation of rotating the liquid applier 31 and the crimper 32 of the edge binder 25 to the inclined binding posture.

The controller 100b drives the edge binder movement motor 55 to move the edge binder 25 in the main scanning direction so that the liquid applier 31 faces the first liquid application position B1 instructed by the binding command (step S701). The controller 100b executes the operation of step S701 before a first sheet P is conveyed to the internal tray 22 by the conveyance roller pairs 10, 11, 14, and 15.

The controller 100b rotates the conveyance roller pairs 10, 11, 14, and 15 to store the sheet P, on which the image has been formed by the image forming apparatus 2, onto the internal tray 22 (step S702). The controller 100b moves the side fences 24L and 24R in the main scanning direction to align the positions of the in the main scanning direction of the sheet P or the sheet bundle Pb stacked on the internal tray 22, in other words, execute so-called jogging process (step S702).

The controller 100b causes the liquid applier 31 facing the first liquid application position B1 to apply liquid to the first liquid application position B1 of the sheet P placed on the internal tray 22 in the immediately preceding step S702, based on the liquid application control data adjusted in advance (step S703). In other words, the controller 100b drives the liquid applier movement motor 42 to bring the liquid application member 501 into contact with the liquid application position B1 on the sheet P placed on the internal tray 22 (see FIG. 12B). In the liquid application process in step S703, the controller 100b adjusts the position at which the liquid application member 501 applies liquid to the sheet P in accordance with the type of the sheet P and the binding position included in the binding command. The controller 100b adjusts the amount of pressing the liquid application member 501 against the sheet P. In other words, the controller 100b controls the driving of the liquid applier movement motor 42 based on the adjusted control data, and adjusts the amount of movement of the liquid application member 501 with respect to the first liquid application position B1 of the sheet P placed on the internal tray 22.

The controller 100b determines whether the number of sheets P placed on the internal tray 22 has reached the given number of sheets N instructed by the binding command (step S704). When the controller 100b determines that the number of sheets P placed on the internal tray 22 has not reached the given number of sheets N (NO in step S704), the controller 100b executes the operations of steps S702 to S704 again until the number of sheets P placed on the internal tray 22 reaches the given number of sheets N (YES in step S704). In other words, the controller 100b executes the processing of steps S702 to S704 each time the sheet P is conveyed to the internal tray 22 by the conveyance roller pairs 10, 11, 14, and 15. The liquid application by the liquid applier 31 may be performed not only on all of the multiple sheets P of the sheet bundle Pb, but also on only a part of the multiple sheets P.

When the controller 100b determines that the number of sheets P placed on the internal tray 22 has reached the given number of sheets N (YES in step S704), the controller 100b drives the edge binder movement motor 55 to move the edge binder 25 in the main scanning direction so that the crimper 32 faces the first binding position B1 as illustrated in FIG. 12C (step S705).

The controller 100b causes the crimper 32 to crimp and bind the sheet bundle Pb placed on the internal tray 22 (step S706). The controller 100b causes the conveyance roller pair 15 to eject the sheet bundle Pb thus crimped and bound by the crimper 32 to the second ejection tray 26 (step S707). Specifically, the controller 100b drives the contact-separation motor 32d to cause the upper crimping teeth 32a and the lower crimping teeth 32b to pinch the first binding position B1 on the sheet bundle Pb placed on the internal tray 22. The sheet bundle Pb is pressed and deformed between the upper crimping teeth 32a and the lower crimping teeth 32b, and thus the sheet bundle Pb is crimped. Then, the controller 100b rotates the conveyance roller pair 15 to eject the sheet bundle Pb thus crimped and bound to the second ejection tray 26.

The sheet bundle Pb that is placed on the internal tray 22 has a crimping area (corresponding to the first binding position B1) sandwiched between the upper crimping teeth 32a and the lower crimping teeth 32b in step S706. The crimping area overlaps a liquid application area (corresponding to the first liquid application position B1) contacted by the tip portion of the liquid application member 501 in step S703. In other words, the crimper 32 crimps an area to which liquid is applied by the liquid applier 31 on the sheet bundle Pb placed on the internal tray 22. The crimping area that is pinched by the upper crimping teeth 32a and the lower crimping teeth 32b may completely or partially overlaps the liquid application area contacted by the distal end (tip portion) of the liquid application member 501, to obtain a sufficient binding strength.

The controller 100b determines whether the number of sheet bundles Pb thus ejected to the second ejection tray 26 has reached the requested number of copies M indicated by the binding command (step S708). When the controller 100b determines that the number of sheet bundles Pb thus ejected has not reached the requested number of copies M (NO in step S708), the controller 100b executes the operations of step S702 and the following steps again. In other words, when the controller 100b determines that the number of sheet bundles Pb thus ejected has not reached the requested number of copies M (YES in step S708), the controller 100b repeats the operations of steps S702 to S708 until the number of sheet bundles Pb ejected to the second ejection tray 26 reaches the requested number of copies M.

When the controller 100b determines that the number of sheet bundles Pb output to the second ejection tray 26 has reached the requested number of copies M (YES in step S708), the controller 100b drives the edge binder movement motor 55 to move the edge binder 25 (the liquid applier 31 and the crimper 32) to the standby position HP as illustrated in FIG. 12A (step S709) When the posture that is instructed by the binding command is the “oblique binding posture”, the controller 100b drives the liquid applier pivot motor 563 and the crimper pivot motor 56 to rotate the liquid applier 31 and the crimper 32 into the parallel binding posture (step S709). On the other hand, when the posture that is instructed by the binding command is the “parallel binding posture”, the controller 100b skips the aforementioned operation of rotating the liquid applier 31 and the crimper 32 to the parallel binding posture. As a result, the edge binder 25 (the liquid applier 31 and the crimper 32) returns to the standby position HP position illustrated in FIG. 12A. In steps S701 and S709, the execution order of the movement in the main scanning direction and the rotation in the forward and reverse directions of the liquid applier 31 and the crimper 32 is not limited to the aforementioned order and may be reversed.

### Configuration of Liquid Applier

A detailed description is given of a configuration of a liquid applier 31 of a post-processing apparatus 3 according to an embodiment of the present disclosure.

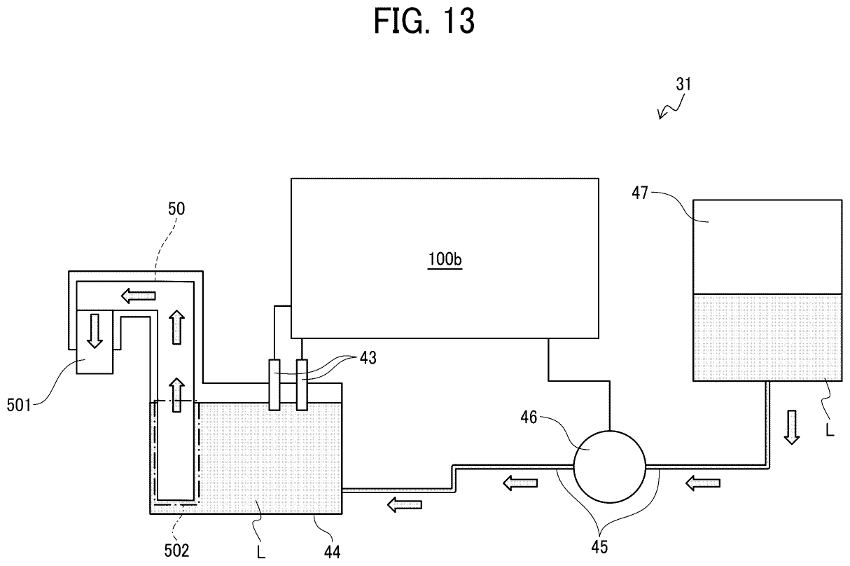

FIG. 13 is a diagram illustrating the liquid applier 31 according to the present embodiment.

The liquid applier 31 includes a liquid supply member 50 having a liquid application member 501, a liquid immersion portion 502, a first liquid storage tank 44 as a first liquid storage, a second liquid storage tank 47 as a second liquid storage, a liquid supply pump 46 as a liquid supplier, a liquid supply passage 45, and a controller 100b as a control unit.

As described above, the liquid supply member 50 is formed of a liquid absorber that has a portion (the liquid immersion portion 502) to be immersed in the liquid stored in the first liquid storage tank 44 and another portion (the liquid application member 501) to come into contact with a sheet P or a sheet bundle Pb to perform the liquid application onto the sheet P or the sheet bundle Pb.

The second liquid storage tank 47 stores liquid to be supplied to the first liquid storage tank 44. The liquid stored in the second liquid storage tank 47 is supplied to the first liquid storage tank 44 through the liquid supply passage 45 by the operation of the liquid supply pump 46.

The first liquid storage tank 44 includes the first liquid level sensor 43 as a first liquid detector for detecting the presence or absence of liquid (i.e., the amount of liquid stored) in the first liquid storage tank 44. The first liquid level sensor 43 is an electrode sensor having a pair of electrodes.

The output value (voltage) output when the first liquid level sensor 43 detects the liquid (liquid level) in the first liquid storage tank 44 is input to the controller 100b as a control unit. The controller 100b determines the presence or absence of liquid (the amount of liquid stored) in the first liquid storage tank 44 based on whether the output value, which is input from the first liquid level sensor 43, exceeds a “liquid detection threshold value” (threshold value). When the controller 100b determines that liquid needs to be replenished to the first liquid storage tank 44, the controller 100b operates the liquid supply pump 46 to supply the liquid from the second liquid storage tank 47 to the first liquid storage tank 44.

The controller 100b controls the timing of application of the voltage to the electrodes of the first liquid level sensor 43. The controller 100b also controls the start and stop of the operation of the liquid supply pump 46 in accordance with the output value of the first liquid level sensor 43. When the first liquid level sensor 43 detects the liquid (liquid level) in the first liquid storage tank 44 by the operation of the liquid supply pump 46 according to the output value of the first liquid level sensor 43, the controller 100b stops the operation of the liquid supply pump 46 and also stops the voltage application to the first liquid level sensor 43.

The controller 100b measures the elapsed time after the operation of the liquid supply pump 46 is stopped. When the elapsed time exceeds a first predetermined time, the controller 100b energizes (i.e., applies a voltage to) the electrodes of the first liquid level sensor 43 and performs the detection process of detecting the liquid (liquid level) in the first liquid storage tank 44 again.

It takes time for the liquid stored in the first liquid storage tank 44 to be drawn up by the capillary phenomenon of the liquid supply member 50 and sent from the liquid immersion portion 502 to the liquid application member 501 through the liquid supply member 50. For this reason, the controller 100b detects the liquid (liquid level) in the first liquid storage tank 44 after waiting for the predetermined time to elapse as described above. At this time, if the liquid supply member 50 draws up the liquid, the amount (liquid level) of liquid stored in the first liquid storage tank 44 decreases, and the first liquid level sensor 43 does not detect the liquid (liquid level) in the first liquid storage tank 44, the controller 100b again operates the liquid supply pump 46 to supply the liquid from the second liquid storage tank 47 to the first liquid storage tank 44.

The output value of the first liquid level sensor 43 corresponds to an electrical signal that changes according to the amount of contact of the electrodes with the liquid in the first liquid storage tank 44. Examples of the electrical signal include, but not limited to, a signal indicating an electrical resistance value, a signal indicating a voltage value, and a signal indicating a current value. In other words, the “electrical signal” may be any signal indicating an electrical value that changes when a current passes between the electrodes (when a voltage is applied) depending on whether the pair of electrodes of the electrode sensor is immersed in the liquid.

In the present embodiment, the electrode sensor has been described as an example of the first liquid level sensor 43. However, the first liquid detector is not limited to the electrode sensor and may be other types of sensors. For example, a float sensor or a capacitance sensor may be used to detect the presence of the liquid. The first liquid level sensor 43 is not limited to a sensor that detects the liquid level (liquid surface) of the liquid in the first liquid storage tank 44, and may be any sensor that can detect the presence or absence of the liquid in the first liquid storage tank 44 (the amount of the liquid stored).

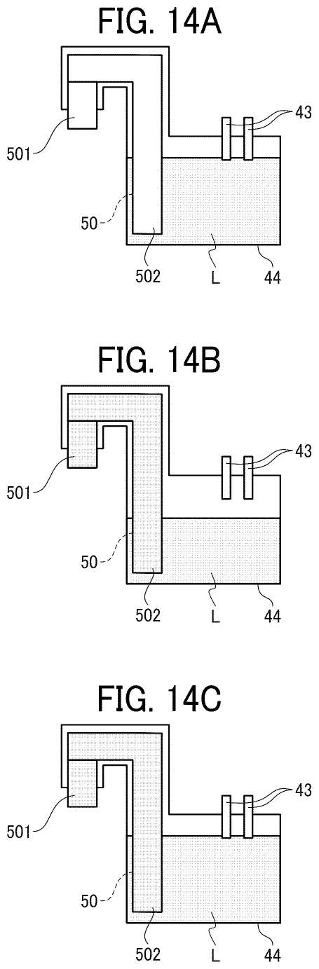

FIGS. 14A, 14B, and 14C are diagrams illustrating a change in the amount (liquid level) of the liquid stored in the first liquid storage tank 44 when the liquid supply member 50 is dry.

A change in the amount (liquid level) of the liquid stored in the first liquid storage tank 44 is referred to as a “liquid level change” below.

First, as illustrated in FIG. 14A, liquid is supplied from the second liquid storage tank 47 to the first liquid storage tank 44, and the first liquid level sensor 43 is set to detect the liquid (liquid level) in the first liquid storage tank 44. At this time, the liquid supply member 50 including the liquid immersion portion 502 is dry. The liquid level (the amount of liquid stored in the first liquid storage tank 44) at the time when the first liquid level sensor 43 detects the liquid in the first liquid storage tank 44 is referred to as a “reference liquid level”.

Then, as illustrated in FIG. 14B, the liquid is sucked up from the liquid immersion portion 502 by the capillary phenomenon, and the liquid supply member 50 is moistened with the sucked liquid. At this time, the amount (liquid level) of liquid stored in the first liquid storage tank 44 is lowered from the reference liquid level. At the stage when the liquid level is lowered, in other words, at the stage when the liquid supply member 50 is moistened by sucking the liquid, the controller 100b determines the output value from the first liquid level sensor 43 again. At this stage, when the controller 100b determines that the amount (liquid level) of liquid stored in the first liquid storage tank 44 is less than the reference liquid level, the controller 100b operates the liquid supply pump 46 to supply the liquid from the second liquid storage tank 47 to the first liquid storage tank 44 again.

In a case where an electrode sensor is used as the first liquid level sensor 43, there is a concern that the metal used for the electrodes might be corroded due to electrolytic corrosion if the pair of electrodes is energized (applied with electricity) constantly. Further, since the voltage is applied to the liquid stored in the first liquid storage tank 44, there is a concern that the liquid might be electrolyzed or that the electrodes might be dissolved due to adhesion of foreign matter to the surface of the electrodes by electrolysis, which might induce deterioration of the electrodes. For this reason, the controller 100b controls the timing of energization of the first liquid level sensor 43 such that the first liquid level sensor 43 is not energized all the time but is energized (energized ON) only when the first liquid level sensor 43 detects the presence or absence (liquid level) of liquid stored in the first liquid storage tank 44.

### Control Process of Liquid Supply Operation

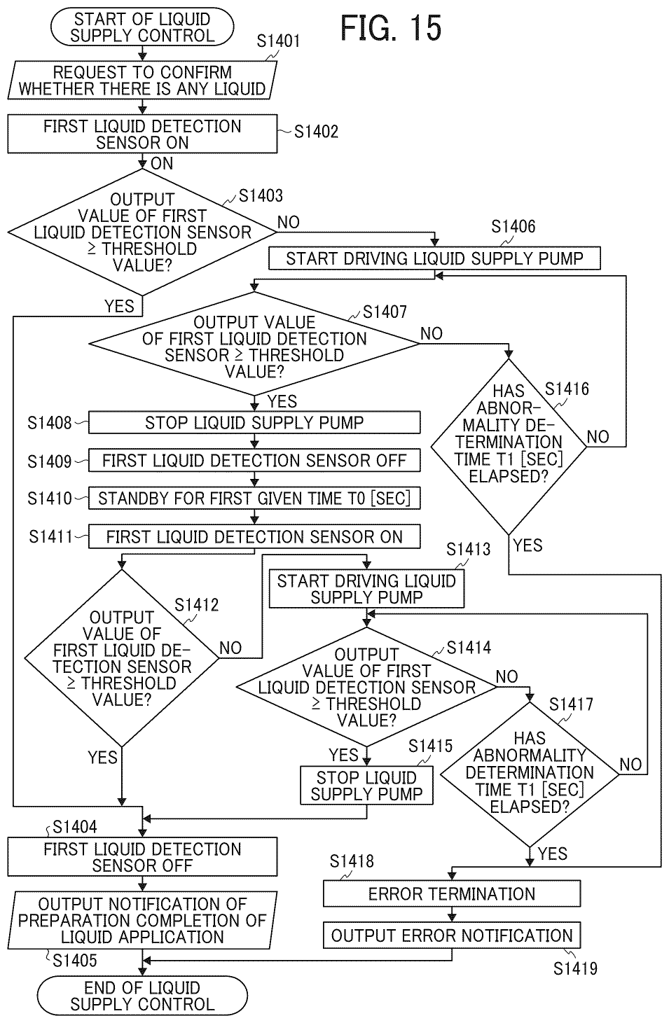

FIG. 15 is a flowchart illustrating a control process (“liquid supply control process”) of the liquid supply operation performed in the controller 100b.

The liquid supply operation according to the present embodiment is executed at the time of starting the post-processing apparatus 3 or at the time of starting the crimp binding process involving liquid application.

For example, when the post-processing apparatus 3 is activated, the liquid supply control process is started. When the liquid supply control process is started, a liquid presence check request is instructed to the controller 100b (step S1401). The liquid presence check request may be instructed based on information input by the user from the operation panel 110 of one or both of the image forming apparatus 2 and the post-processing apparatus 3. In response to receipt of the liquid presence check request instructed from the image forming apparatus 2, the controller 100b applies a voltage to the first liquid level sensor 43 (turns on energization) (step S1402).

Subsequently, the controller 100b acquires a value of an electrical signal (referred to as an “output value” in the following description) output when the first liquid level sensor 43 detects liquid in the first liquid storage tank 44, and determines the presence or absence of the liquid (the amount of the liquid stored) in the first liquid storage tank 44 (step S1403). The determination of the presence of liquid (the stored liquid amount) in the first liquid storage tank 44 is performed based on whether the output value (voltage) output from the first liquid level sensor 43 exceeds a “liquid detection threshold value” (threshold value) set in advance. For example, when the output value (voltage) from the first liquid level sensor 43 is equal to or greater than the liquid detection threshold value (e.g., output voltage VTh1), the controller 100b determines that the amount of liquid stored in the first liquid storage tank 44 is a sufficient amount (YES in step S1403). In this case, the controller 100b stops the application of the voltage to the first liquid level sensor 43 (turns the energization of the first liquid level sensor 43 off) (step S1404), displays a completion notice of the preparation for liquid application on, for example, the operation panel 110 (step S1405), and ends the liquid supply control process.

On the other hand, when the output value (voltage) from the first liquid level sensor 43 is less than the liquid detection threshold value (e.g., the output voltage VTh1) in step S1403 (NO in step S1403), the controller 100b operates the liquid supply pump 46 to execute the supply of the liquid from the second liquid storage tank 47 to the first liquid storage tank 44 (step S1406).

Subsequently, the controller 100b determines whether the output value (voltage) from the first liquid level sensor 43 is equal to or greater than the “liquid detection threshold value” (threshold value) set in advance (step S1407). When the output value (voltage) from the first liquid level sensor 43 is equal to or greater than the liquid detection threshold value (e.g., the output voltage VTh1), the controller 100b determines that a sufficient amount of liquid has been supplied from the second liquid storage tank 47 into the first liquid storage tank 44 by the liquid supply pump 46 (YES in step S1407). On the other hand, when the output value (voltage) from the first liquid level sensor 43 is less than the liquid detection threshold value (e.g., the output voltage VTh1) (NO in step S1407), the controller 100b determines whether an elapsed time from the start (step S1406) of the operation of the liquid supply pump 46 has exceeded an abnormality determination time (T1 seconds) (step S1416). When the elapsed time has not reached the abnormality determination time T1 (NO in step S1416), the controller 100b continues the supply of the liquid from the second liquid storage tank 47 to the first liquid storage tank 44 by the liquid supply pump 46 until the output value (voltage) from the first liquid level sensor 43 becomes equal to or greater than the liquid detection threshold value (e.g., output voltage V1) (YES in step S1407).

On the other hand, when the elapsed time has reached the abnormality determination time T1 (YES in step S1416), the controller 100b determines that some abnormality (such as a failure of at least one of the liquid supply pump 46 or the first liquid level sensor 43) has occurred in a device, and executes an error stop process of at least one of stopping the liquid supply pump 46 and turning off the energization of the first liquid level sensor 43 (step S1418). The controller 100b causes the operation panel 110 to display an abnormality notification (step S1419), and ends the liquid supply control process.

When the output value (voltage) from the first liquid level sensor 43 becomes equal to or greater than the liquid detection threshold value (e.g., output voltage VTh1) in step S1407 (YES in step S1407), the controller 100b stops the liquid supply pump 46 and stops the supply of liquid from the second liquid storage tank 47 to the first liquid storage tank 44 (step S1408). The controller 100b stops the application of voltage to the first liquid level sensor 43 (turns off the energization) (step S1409).

Then, the liquid supply control process is temporarily stopped until a standby time (first predetermined time TO seconds) elapses. The standby time is set in advance as a time taken until the liquid supply member 50 sucks up liquid in the first liquid storage tank 44 by, e.g., capillary phenomenon and the liquid application member 501 turns to an executable state for liquid application (a state where the liquid is sufficiently stored in at least one of the liquid application member 501 and the liquid supply member 50) (step S1410).

After the first predetermined time TO has elapsed, the controller 100b turns on the energization of the first liquid level sensor 43 again (in step S1411), acquires an output value (voltage) that is output when the first liquid level sensor 43 detects the liquid in the first liquid storage tank 44, and determines the presence (the stored liquid amount) of liquid in the first liquid storage tank 44 (in step S1412). At this stage, the liquid level (stored liquid amount) of the liquid in the first liquid storage tank 44 is lowered by the suction of the liquid supply member 50. However, if the output value (voltage) from the first liquid level sensor 43 is equal to or greater than the liquid detection threshold value (e.g., the output voltage VTh1) (YES in step S1412), the controller 100b stops the application of the voltage to the first liquid level sensor 43 (i.e., turns the first liquid level sensor 43 off) (step S1404). The controller 100b displays a completion notice of the preparation for liquid application on, for example, the operation panel 110 (step S1405), and ends the liquid supply control process.

On the other hand, when the output value (voltage) from the first liquid level sensor 43 is less than the liquid detection threshold value (e.g., the output voltage VTh1) in step S1412 (NO in step S1412), the controller 100b operates the liquid supply pump 46 to execute the supply of the liquid from the second liquid storage tank 47 to the first liquid storage tank 44 (step S1413).

Subsequently, the controller 100b acquires an output value (voltage) that is output when the first liquid level sensor 43 detects liquid in the first liquid storage tank 44, and determines the presence (the stored liquid amount) of liquid in the first liquid storage tank 44 (step S1414). Subsequently, when the output value (voltage) from the first liquid level sensor 43 is equal to or greater than the liquid detection threshold value (e.g., the output voltage VTh1) (YES in step S1414), the controller 100b determines that a sufficient amount of liquid has been supplied into the first liquid storage tank 44. In this case, the controller 100b stops the liquid supply pump 46 to stop the supply of liquid from the second liquid storage tank 47 to the first liquid storage tank 44 (step S1415). Then, the controller 100b stops the application of the voltage to the first liquid level sensor 43 (turns the energization of the first liquid level sensor 43 off) (step S1404), displays a completion notice of the preparation for liquid application on, for example, the operation panel 110 (step S1405), and ends the liquid supply control process.

On the other hand, when the output value (voltage) from the first liquid level sensor 43 is less than the liquid detection threshold value (e.g., the output voltage VTh1) (NO in step S1414), the controller 100b determines whether the elapsed time from the start (step S1413) of the operation of the liquid supply pump 46 has reached the abnormality determination time (T1 seconds) (step S1417). When the elapsed time has not reached the abnormality determination time T1 (NO in step S1417), the controller 100b continues the supply of the liquid from the second liquid storage tank 47 to the first liquid storage tank 44 by the liquid supply pump 46 until the output value (voltage) from the first liquid level sensor 43 becomes equal to or greater than the liquid detection threshold value (e.g., the output voltage VTh1) (YES in step S1414).

On the other hand, when the elapsed time has reached the abnormality determination time T1 (YES in step S1414), the controller 100b determines that some kind of abnormality has occurred in the apparatus, and executes the error stop process of at least one of stopping the liquid supply pump 46 and turning off the energization of the first liquid level sensor 43 (step S1418). The controller 100b causes the operation panel 110 to display an abnormality notification (step S1419), and ends the liquid supply control process.

The “abnormality notification” may be, for example, a display of a warning on the operation panel 110 to prompt a check because there is a possibility that one or both of the liquid supply pump 46 and the first liquid level sensor 43 are out of order.

As described above, the execution of the control process of the liquid supply operation according to the present embodiment can stably obtain a certain amount of liquid in at least one of the liquid supply member 50 and the liquid application member 501, which enables liquid application by the liquid application member 501. As a result, the frequency of the liquid supply operation from the second liquid storage tank 47 to the first liquid storage tank 44 can be reduced, and the efficiency of the liquid application process can be enhanced.

A description is given below of the relation between the liquid supply control process with reference to FIG. 15 and the change in the amount (liquid level) of the liquid stored in the first liquid storage tank 44 with reference to FIGS. 14A, 14B, and 14C.

First, when the presence or absence of liquid in the first liquid storage tank 44 is checked in the stage preceding to the state illustrated in FIG. 14A, the controller 100b determines that state in the first liquid storage tank 44 is the state of “no liquid” (NO in step S1403) and drives the liquid supply pump 46 to supply liquid from the second liquid storage tank 47 to the first liquid storage tank 44 (step S1406). When the amount (liquid level) of the liquid stored in the first liquid storage tank 44 reaches the state of FIG. 14A, the output value (voltage) from the first liquid level sensor 43 becomes equal to or greater than the liquid detection threshold value (e.g., the output voltage VTh1) (YES in step S1407). The controller 100b stops the liquid supply pump 46 (step S1408) and turns off the energization of the first liquid level sensor 43 (step S1409).

Subsequently, when the first predetermined time TO, which is set in advance as the time taken until the liquid supply member 50 sucks up liquid as illustrated in FIG. 14B and thereby the liquid application member 501 turns to an executable state for liquid application, has elapsed, the controller 100b turns on the energization of the first liquid level sensor 43 again (step S1411). At this stage, a predetermined amount of liquid is sucked up by the liquid supply member 50 from the first liquid storage tank 44 to the liquid supply member 50. As a result, the amount of the liquid stored in the first liquid storage tank 44 decreases and the liquid level of the liquid (stored liquid amount) in the first liquid storage tank 44 becomes lower than the reference liquid level. As a result, the output value (voltage) from the first liquid level sensor 43 becomes less than the liquid detection threshold value (e.g., the output voltage VTh1) (NO in step S1412).

Then, the controller 100b causes the liquid supply pump 46 to operate again (step S1413) and executes supply of the liquid from the second liquid storage tank 47 to the first liquid storage tank 44 until the output value (voltage) from the first liquid level sensor 43 becomes equal to or greater than the liquid detection threshold value (e.g., the output voltage VTh1) (YES in step S1414). When the output value (voltage) from the first liquid level sensor 43 becomes equal to or greater than the liquid detection threshold value (e.g., the output voltage VTh1), the controller 100b stops the liquid supply pump 46 (step S715) and turns off the energization of the first liquid level sensor 43 (step S1404). As a result, as illustrated in FIG. 14C, the liquid in the first liquid storage tank 44 is sufficiently stored in the entirety of at least one of the liquid supply member 50 and the liquid application member 501, and the controller 100b causes the operation panel 110 to display the completion notice of the preparation for liquid application (step S1405).

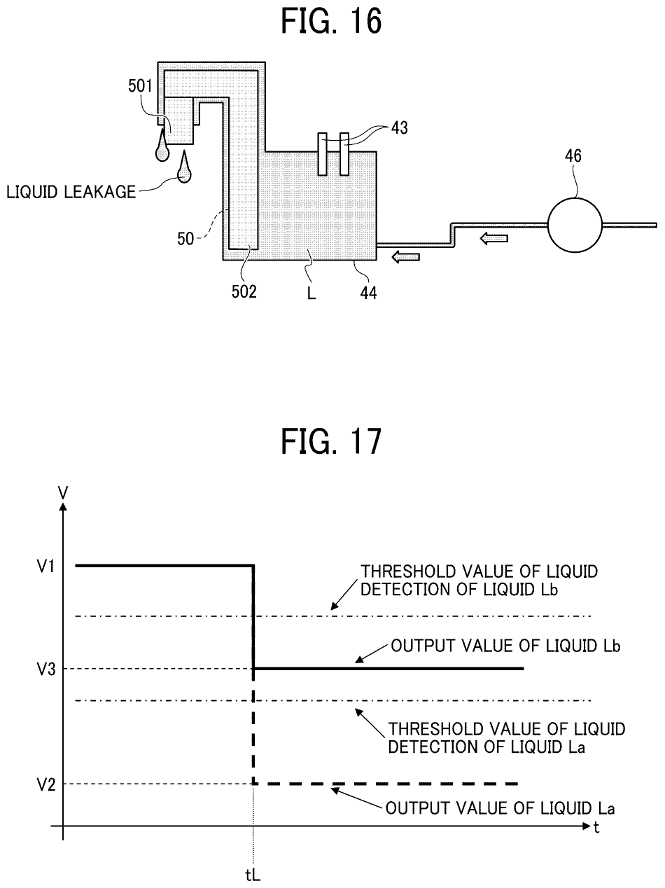

FIG. 16 is a diagram illustrating liquid leakage that might occur in the liquid applier 31 according to the present embodiment.

The liquid applier 31 according to the present embodiment supplies liquid to the second liquid storage tank 47. Accordingly, the properties (e.g., hardness, pH, chlorine content, and conductance) of the liquid vary depending on the type of the liquid supplied to the second liquid storage tank 47. In other words, when the presence or absence of liquid (the amount of liquid stored) in the first liquid storage tank 44 is determined based on the output value (voltage) of the first liquid level sensor 43, it is assumed that a situation may arise in which it is difficult to accurately detect the presence or absence of liquid (the amount of liquid stored) in the first liquid storage tank 44 even if the determination is made with the liquid detection threshold value fixed at a specific value.

For example, it is assumed that the liquid supplied into the first liquid storage tank 44 is a liquid having extremely low conductance (e.g., ultrapure water used in the industrial field). It is further assumed that the liquid detection threshold value set on the premise of tap water is used. In such a case, even when the liquid in the first liquid storage tank 44 contacts the first liquid level sensor 43, the output value (output value of ultrapure water) at that time may not satisfy the condition for detecting the liquid (liquid level) in the first liquid storage tank 44 in comparison with the liquid detection threshold value set on the premise of tap water. As a result, the supply of the liquid to the first liquid storage tank 44 by the liquid supply pump 46 would not be stopped at an appropriate timing, and the first liquid storage tank 44 would entirely be filled with the liquid, which may cause a failure such as a gap between the liquid supply member 50 and the first liquid storage tank 44 or liquid leakage from the tip of the liquid application member 501 as illustrated in FIG. 16.

For this reason, the liquid applier 31 according to the present embodiment varies the liquid detection threshold value used for determining the presence or absence of the liquid in the first liquid level sensor 43 depending on the type of the liquid.

FIG. 17 is a graph illustrating the relation between the change in the output value from the first liquid level sensor 43 and the liquid detection threshold value of the first liquid level sensor 43 in time series.

In FIG. 17, the horizontal axis t represents the elapsed time when the liquid supply pump 46 is operated to supply the liquid from the second liquid storage tank 47 to the first liquid storage tank 44, and the vertical axis V represents the output value (voltage) of the first liquid level sensor 43.

Before the pair of electrodes of the first liquid level sensor 43 comes into contact with the liquid in the first liquid storage tank 44 (see FIG. 14B), the air is detected with the first liquid level sensor 43. The output value (voltage) of the first liquid level sensor 43 at this time is referred to as “V1”. If the liquid type is “La” having a predetermined conductance, the output value (voltage) is assumed to change from “V1” to “V2” when the liquid La contacts the electrodes at the elapsed time tL. Then, in order to detect the liquid La with the first liquid level sensor 43, the controller 100b sets the liquid detection threshold value of the first liquid level sensor 43 between the output value V1 and the output value V2 as illustrated in FIG. 17.

The liquid detection threshold value of the first liquid level sensor 43 is preferably set to an intermediate value between the output value V1 and the output value V2 in consideration of, for example, variations and noise in the output value V1 and the output value V2.

When the liquid type is not “La” but “Lb” having a lower conductance than “La”, the output value is assumed to change from “V1” to “V3” when the liquid Lb comes into contact with the electrodes. The output value V3 is assumed to be greater than the output value V2 and smaller than the output value V1. In this case, when the liquid Lb comes into contact with the electrodes at the elapsed time tL, the output value changes from “V1” to “V3” and does not reach “V2”. In other words, even if the liquid detection threshold value of the first liquid level sensor 43 (liquid detection threshold value for the liquid La) is set to an intermediate value between the output value V1 and the output value V2 as illustrated in FIG. 17, the liquid level (stored liquid amount) of the liquid Lb in the first liquid storage tank 44 is not detected by the first liquid level sensor 43.

For this reason, in the case of the liquid Lb, the controller 100b sets the liquid detection threshold value of the first liquid level sensor 43 to an intermediate value between the output value V1 and the output value V3, not the intermediate value between the output value V1 and the output value V2 as illustrated in FIG. 17. In other words, the liquid detection threshold value of the first liquid level sensor 43 is changed depending on the type of the liquid such that the first liquid level sensor 43 can accurately detect the liquid (liquid level) in the first liquid storage tank 44.

### Modification of First Embodiment

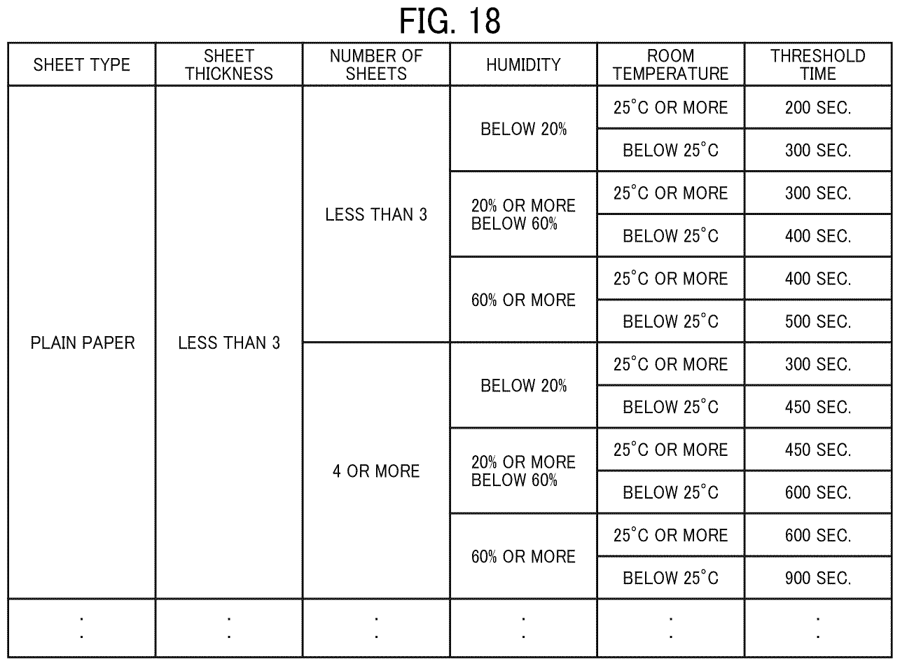

A description is given of a post-processing apparatus 3 according to a first embodiment, with reference to FIGS. 18 to 21.

A detailed description of features in common with the first embodiment is omitted, and differences will be mainly described. The basic configuration of the post-processing apparatus 3 according to the modification is in common with the first embodiment. On the other hand, the post-processing apparatus 3 according to the modification is different from that of the first embodiment in that liquid can be reapplied (or discharged without crimp binding) to the sheet P supported by the internal tray 22 (first tray) in the binding process.

FIG. 18 is a table indicating a data example of a threshold time.

The table of the threshold time is a table for managing a threshold time for determining whether to reapply (or discharge without crimp binding) liquid to the sheet P. The table of the threshold time is stored in, for example, a memory (for example, the HDD 104). Then, the controller 100b determines whether to reapply (or discharge without crimp binding) the liquid to the sheet P based on the table of the threshold time.

For example, the table of the threshold time stores the threshold time in association with at least one of the type of the sheet P (sheet type), the thickness of the sheet P (sheet thickness), the number of sheets P currently supported on the internal tray 22, the humidity of the installation location of the post-processing apparatus 3, and the room temperature of the installation location of the post-processing apparatus 3. In other words, the controller 100b adjusts the threshold time used in step S2107 based on at least one of the type of the sheet P (sheet type), the thickness of the sheet P (sheet thickness), the number of sheets P currently supported on the internal tray 22, the humidity of the installation location of the post-processing apparatus 3, and the room temperature of the installation location of the post-processing apparatus 3.

As an example, the controller 100b sets the threshold time to be shorter when the sheet P is plain paper than when the sheet P is coated paper. As another example, the controller 100b shortens the threshold time as the sheet thickness is thinner, and lengthens the threshold time as the sheet thickness is thicker. As another example, the controller 100b shortens the threshold time as the number of sheets P currently supported on the internal tray 22 is smaller, and lengthens the threshold time as the number of sheets P currently supported on the internal tray is larger.

As another example, the controller 100b shortens the threshold time as the humidity is lower, and lengthens the threshold time as the humidity is higher. As still another example, the controller 100b shortens the threshold time as the temperature is higher, and lengthens the threshold time as the temperature is lower. The controller 100b may acquire humidity (temperature) from a hygrometer (thermometer) mounted on the post-processing apparatus 3 (or the image forming system 1). Alternatively, the controller 100b may acquire humidity (temperature) from a hygrometer (thermometer) installed outside through a communication network.

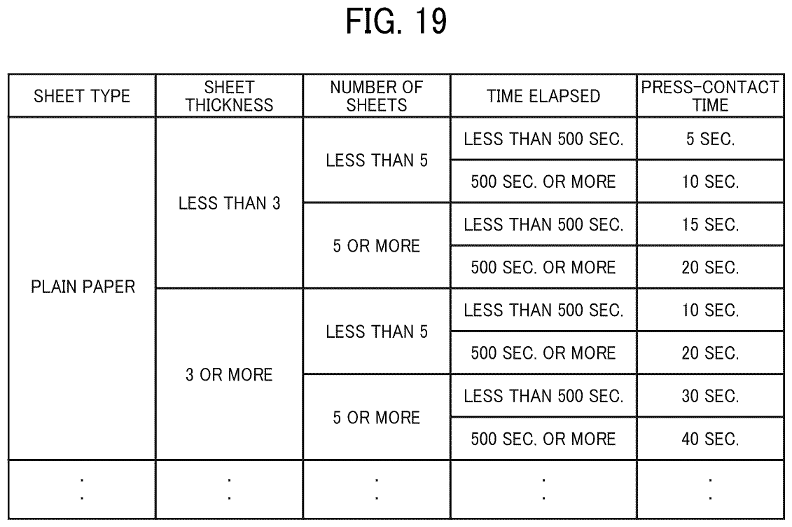

FIG. 19 is a table of a data example of a pressing time.

The table of the pressing time is a table for managing a pressing time for pressing the liquid application member 501 against the sheet P. The table of the pressing time is stored in, for example, a memory (for example, the HDD 104). Then, the controller 100b increases or decreases the time for pressing the liquid application member 501 against the sheet P based on the table of the pressing time. The longer the pressing time, the larger the amount of liquid to be reapplied to the sheet P. In other words, the controller 100b adjusts the amount of liquid to be reapplied to the sheet P by increasing or decreasing the pressing time.

The table of the pressing time stores the pressing time in association with, for example, at least one of the type of the sheet P (sheet type), the thickness of the sheet P (sheet thickness), or the elapsed time since the liquid was applied to the sheet P. In other words, the controller 100b adjusts the amount of liquid to be reapplied to the sheet P based on at least one of the type of the sheet P (sheet type), the thickness of the sheet P (sheet thickness), or the elapsed time since the liquid was applied to the sheet P.

As an example, the controller 100b shortens the pressing time in a case where the sheet P is plain paper as compared with a case where the sheet P is coated paper. As another example, the controller 100b shortens the pressing time as the paper thickness is thinner, and lengthens the pressing time as the paper thickness is thicker. As another example, the controller 100b shortens the pressing time as the number of sheets P currently supported on the internal tray 22 is smaller, and lengthens the pressing time as the number of sheets P currently supported on the internal tray is larger. As still another example, the controller 100b shortens the pressing time as the elapsed time from the first application of the liquid to the sheet P is shorter, and lengthens the pressing time as the elapsed time is longer.

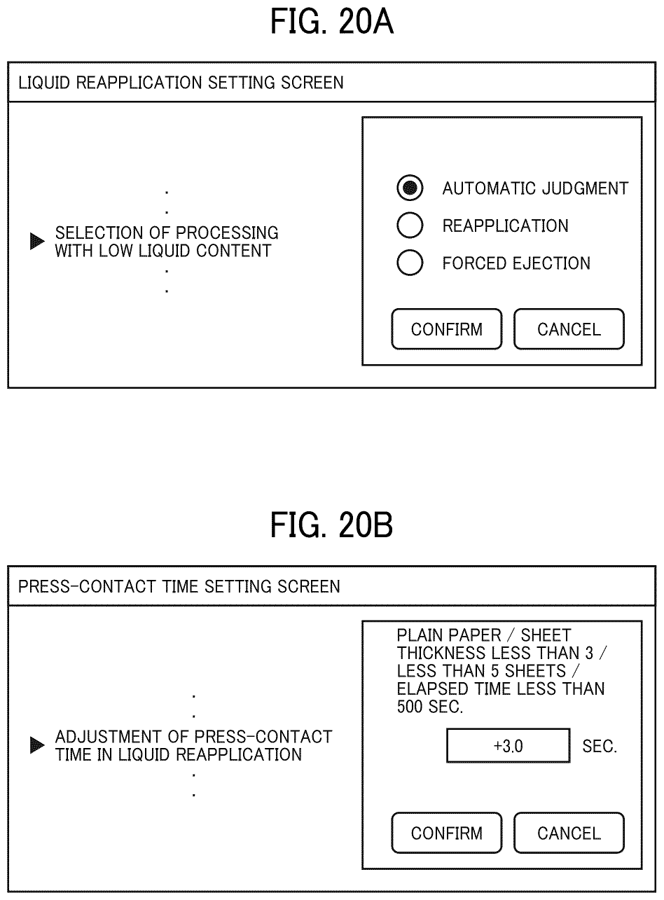

FIGS. 20A and 20B are screen examples of the reapplication setting screen (A) and the pressing time setting screen (B).

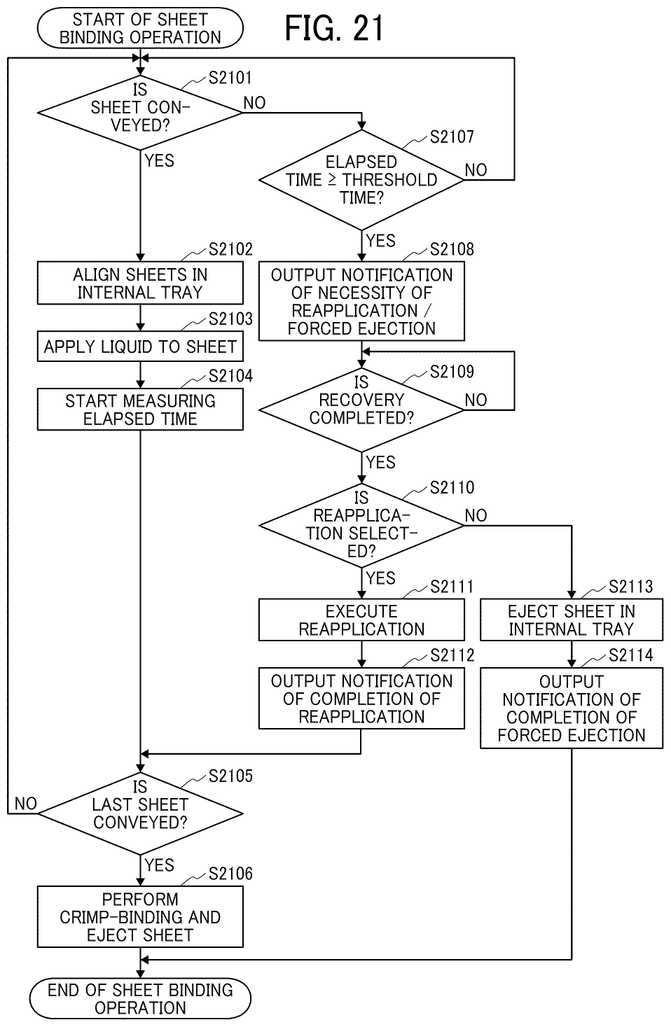

The controller 100b displays a reapplication setting screen or a pressing time setting screen on the operation panel 110 prior to the binding process described later with reference to FIG. 21. In other words, the controller 100b causes the operation panel 110 to display the reapplication setting screen or the pressing time setting screen in accordance with the operation of the user through the operation panel 110.

The reapplication setting screen is a screen for setting whether to reapply the liquid to the sheet P1 or to forcibly discharge the sheet P or the sheet bundle Pb currently supported on the internal tray 22 to the second ejection tray 26 (second tray) without crimping and binding the sheet P or the sheet bundle Pb when an elapsed time from when the liquid is applied to the sheet P1 (first medium) to when the subsequent sheet P2 (second medium) is conveyed to the internal tray 22 reaches a threshold time. As illustrated in FIG. 20A, the reapplication setting screen includes radio buttons respectively corresponding to “automatic determination” indicating that the controller 100b automatically determines reapplication and forced discharge, “reapplication” indicating reapplication, and “forced discharge” indicating forced discharge, a [confirm] icon, and a [cancel] icon.

Then, when one of the radio buttons is selected and the [confirm] icon is tapped, the controller 100b stores (changes) the setting corresponding to the selected radio button in the HDD 104. On the other hand, when the [cancel] icon is tapped, the controller 100b cancels the setting change. The initial value of the reapplication setting is, for example, “automatic determination”.

The pressing time setting screen is a screen for allowing the user to set the pressing time. As illustrated in FIG. 20B, the pressing time setting screen includes a text box for inputting an increased/decreased value of the pressing time corresponding to the parameter (for example, plain paper, paper thickness of less than 3 (257 to 280 g/m2), less than 5 sheets, elapsed time of less than 500 seconds) of the table of the pressing time, a [confirm] icon, and a [cancel] icon. The corresponding parameter can be changed through the operation panel 110.

Then, when the [confirm] icon is tapped, the controller 100b adds or subtracts the numerical value input to the text box to or from the corresponding pressing time in the table of the pressing time. On the other hand, when the [cancel] icon is tapped, the controller 100b cancels the change in pressing time. An initial value of the pressing time is set in the table of the pressing time in advance, for example.

### Modification of Binding Process

FIG. 21 is a flowchart of a binding process according to a modification.

Detailed description of points in common with the processing of FIG. 11 will be omitted, and differences will be mainly described.

First, when the sheet P on which an image has been formed by the image forming apparatus 2 is supplied to the internal tray 22 (YES in step S2101), the controller 100b performs a so-called jogging process in which the side fences 24L and 24R are also moved in the main scanning direction to align the position of the sheet P or the sheet bundle Pb placed on the internal tray 22 in the main scanning direction (step S2102).

The controller 100b causes the liquid applier 31 to execute liquid application to the liquid application position of the sheet P supported on the internal tray 22 immediately before (step S2103). The controller 100b starts measuring the elapsed time after executing step S2103 (step S2104). The controller 100b determines whether the number of sheets P placed on the internal tray 22 has reached the given number of sheets N (in other words, the last sheet) (step S2105).

Then, the controller 100b repeatedly executes the processing of steps S2101 to S2104 until it is determined that the sheet P placed on the internal tray 22 is the last sheet (NO in step S2105). More particularly, when the subsequent sheet P2 (second medium) has been conveyed (YES in step S2101) before the elapsed time from the application of the liquid to the immediately preceding sheet P1 (first medium) reaches the threshold time (NO in step S2107), the controller 100b executes the processing in steps S2102 to S2104 on the sheet P2. The controller 100b determines the threshold time based on the table of the threshold time illustrated in FIG. 18 every time step S2107 is executed.

Further, when determining that the sheet P placed on the internal tray 22 is the last sheet (YES in step S2105), the controller 100b causes the crimper 32 to crimp and bind the binding position of the sheet bundle Pb placed on the internal tray 22, and causes the conveyance roller pair 15 to discharge the crimped and bound sheet bundle Pb to the second ejection tray 26 (step S2106).

On the other hand, when the elapsed time from the immediately preceding step S2104 has reached the threshold time (YES in step S2107) before the sheet P2 subsequent to the sheet P1 is conveyed to the internal tray 22 (NO in step S2101), the controller 100b notifies the controller 100a of the image forming apparatus 2 of the necessity of reapplication or forced discharge at the timing when the elapsed time has reached the threshold time (step S2108). The controller 100b continues the measurement of the elapsed time.

When the elapsed time reaches the threshold time until the subsequent sheet P2 is conveyed to the internal tray 22 (NO in step S2101 & YES in step S2107), for example, it is conceivable that a trouble to fail to supply the sheet P2 to the internal tray 22 occurs. As an example of the trouble, it is conceivable that the sheet P2 is jammed (so-called paper jam) on the conveyance passage from the image forming apparatus 2 to the internal tray 22, and the sheets P stored in the sheet tray 211 run out. These troubles may occur in the image forming apparatus 2 or in the post-processing apparatus 3.

Therefore, when the controller 100a receives the notification of step S2108, the controller 100a waits for the conveyance of the subsequent sheet P until receiving the notification of step S2112/S2114 from the controller 100b. When a trouble in the image forming apparatus 2 is recovered, the controller 100a notifies (hereinafter, it is described as “recovery notification”) the controller 100b of completion of the recovery.

When a trouble occurs in the image forming apparatus 2, the controller 100b waits for execution of the processing in and after step S2110 until receiving a recovery notification from the controller 100a (NO in step S2109). On the other hand, when a trouble occurs in the post-processing apparatus 3, the controller 100b waits for execution of the processing in and after step S2110 until receiving an operation indicating that the trouble is recovered through the operation panel 110 (NO in step S2109). In other words, the controller 100b waits for execution of the processing in and after step S2110 until the sheet P2 can be supplied to the internal tray 22 (NO in step S2109).

Then, in response to completion of recovery of trouble (in other words, the subsequent sheet P2 can be conveyed) (YES in step S2109), the controller 100b determines whether to reapply the liquid to the sheet P1 or to discharge the sheet P1 placed on the internal tray 22 or the sheet bundle Pb including the sheet P1 without performing the crimp binding (step S2110). For example, the controller 100b performs the determination in step S2110 based on the setting value stored in the HDD 104.

When “reapplication” is selected on the reapplication setting screen (YES in step S2110), the controller 100b executes the processing in and after step S2111. When “forced discharge” is selected on the reapplication setting screen (NO in step S2110), the controller 100b executes the processing of step S2113 and subsequent steps. In other words, the controller 100b may perform the determination in step S2110 based on the operation of the user through the operation panel 110.

On the other hand, when “automatic determination” is selected on the reapplication setting screen, the controller 100b may perform the determination in step S2110 based on, for example, at least one of the type of the sheet P1 (sheet type), the thickness of the sheet P1 (sheet thickness), the number of sheets P currently supported on the internal tray 22, the amount of liquid contained in the sheet P1, and the number of times of reapplication (step S2111) performed so far in the current binding process.

As an example, the controller 100b performs reapplication of liquid when the sheet P1 is plain paper, and performs forced discharge when the sheet P1 is coated paper. As another example, the liquid is reapplied when the sheet thickness of the sheet P1 is equal to or less than the threshold value, and forced discharge is performed when the sheet thickness of the sheet P1 is equal to or more than the threshold value. As another example, the controller 100b performs reapplication of liquid when the number of sheets P at the present time is smaller than a threshold value, and performs forced discharge when the number of sheets P at the present time is equal to or larger than the threshold value.

As another example, the controller 100b performs reapplication of liquid when the amount of liquid contained in the sheet P1 at the present time is equal to or more than a threshold value, and performs forced discharge when the amount of liquid contained in the sheet P1 at the present time is less than the threshold value. The current liquid content of the sheet P1 may be measured by, for example, a measuring instrument mounted on the post-processing apparatus 3. As still another example, the controller 100b performs reapplication of liquid when the number of times of reapplication in the current binding process is less than a threshold value, and performs forced discharge when the number of times of reapplication is equal to or greater than the threshold value.

When it is determined to reapply the liquid (YES in step S2110), the controller 100b causes the liquid applier 31 to reapply the liquid to the liquid applying position on the sheet P1 (step S2111). The controller 100b adjusts the amount of liquid to be reapplied (time for pressing the liquid application member 501) according to the table of the pressing time illustrated in FIG. 19, for example. The controller 100b notifies the controller 100a of completion of reapplication of the liquid at a timing when the reapplication of the liquid is completed (step S2112). In response to receiving the notification in step S2112, the controller 100a restarts the supply of the sheet P2 to the post-processing apparatus 3. Then, the controller 100b executes the processing of step S2105 and subsequent steps.

When it is determined to perform forced discharge (NO in step S2110), the controller 100b discharges the sheet P or the sheet bundle Pb supported by the internal tray 22 to the second ejection tray 26 without performing the crimp binding (step S2113). As another example, the controller 100b may instruct the user to discharge the sheet P or the bundle of sheets Pb from the internal tray 22 through the operation panel 110. The controller 100b notifies the controller 100a of the completion of forced discharge at the timing when the forced discharge of the sheet P supported on the internal tray 22 is completed (step S2114). In response to the reception of the notification in step S2114, the controller 100a re-supplies the first sheet P to be crimped and bound in the current binding process to the post-processing apparatus 3. Then, the controller 100b temporarily ends the current binding process and starts a new binding process.

### Operation and Effect of Modification

According to the above modified example, by enabling the reapplication of the liquid to the sheet P1, it is possible to obtain appropriate binding strength even in a case where a long time has elapsed while the sheet P2 subsequent to the sheet P1 is not supplied to the internal tray 22. Since the sheet P supported by the internal tray 22 so far is not wasted, it is possible to reduce the waiting time of the user and waste paper.

According to the above modification, the liquid content of the sheet P1 can be appropriately determined by determining the threshold time based on the table of the threshold time. As a result, excess or deficiency of the liquid to be reapplied can be prevented, and an appropriate binding strength can be obtained. As another example, the controller 100b may reapply the liquid to the sheet P1 when the liquid content of the sheet P1 measured by a measuring instrument mounted on the post-processing apparatus 3 is less than a threshold value.

According to the above modification, an appropriate amount of liquid can be reapplied by adjusting the amount of liquid to be reapplied based on the table of the pressing time. As a result, excess or deficiency of the liquid to be reapplied can be prevented, and an appropriate binding strength can be obtained. As another example, the controller 100b may adjust the amount of liquid to be reapplied based on the liquid content of the sheet P1 measured by a measuring instrument mounted on the post-processing apparatus 3.

According to the above modified example, by selecting whether to reapply the liquid to the sheet P1 or to forcibly discharge the sheet P so far, it is possible to switch between reduction in the waiting time of the user and waste paper and quality maintenance of the bundle of paper Pb to be crimped and bound.

As an example, the controller 100b automatically determines the reapplication and the forced discharge, so that it is possible to achieve both reduction in the waiting time of the user and waste paper and quality maintenance of the bundle of sheets Pb to be crimped and bound. As another example, by allowing the user to select the reapplication and the forced ejection, it is possible to allow the user to select which of the reduction in the waiting time of the user and waste paper and quality maintenance of the bundle of sheets Pb to be crimped and bound is prioritized.

According to the above modification, by reapplying the liquid after the recovery is completed (YES in step S2109 to step S2111), it is possible to prevent the waiting time from becoming long again after reapplying the liquid. Thus, it is possible to prevent deterioration in quality of the sheet P1 due to repetition of reapplication of liquid.

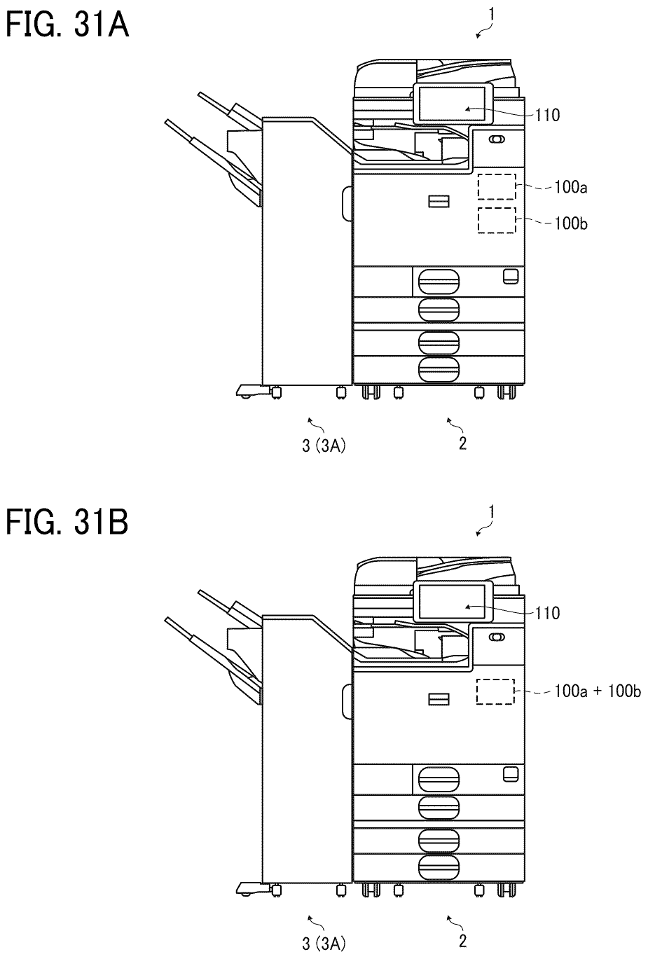

In the above description, the controller 100b of the post-processing apparatus 3 is provided separately from the controller 100a of the image forming apparatus 2 as illustrated in FIG. 1. However, embodiments of the present disclosure are not limited to the above-described configuration. For example, as illustrated in FIG. 31A, the controller 100b of the post-processing apparatus 3 may be disposed in the image forming apparatus 2. As illustrated in FIG. 31B, the controller 100b of the post-processing apparatus 3 may be integrated with the controller 100a of the image forming apparatus 2.

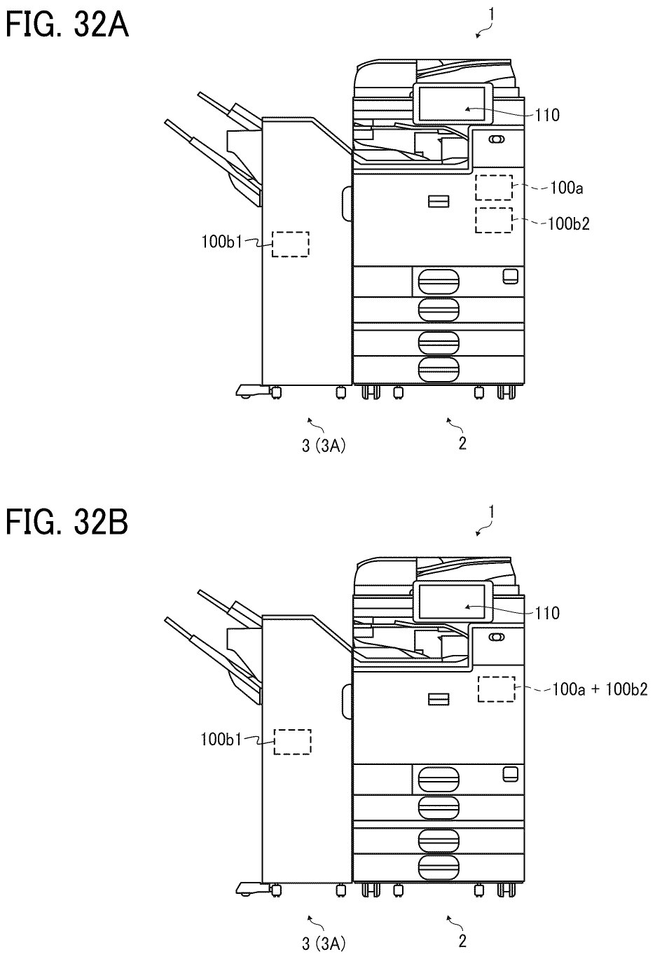

As illustrated in FIG. 32A, the controller 100b of the post-processing apparatus 3 may be divided into a controller 100b1 (e.g., a drive unit such as a motor) and a controller 100b2 (a detector such as a sensor) according to the function, and the controller 100b2 of the post-processing apparatus 3 may be disposed in the image forming apparatus 2. As illustrated in FIG. 32B, the controller 100b2 of the post-processing apparatus 3 disposed in the image forming apparatus 2 may be integrated with the controller 100a of the image forming apparatus 2.

### Second Embodiment of Post-Processing Apparatus

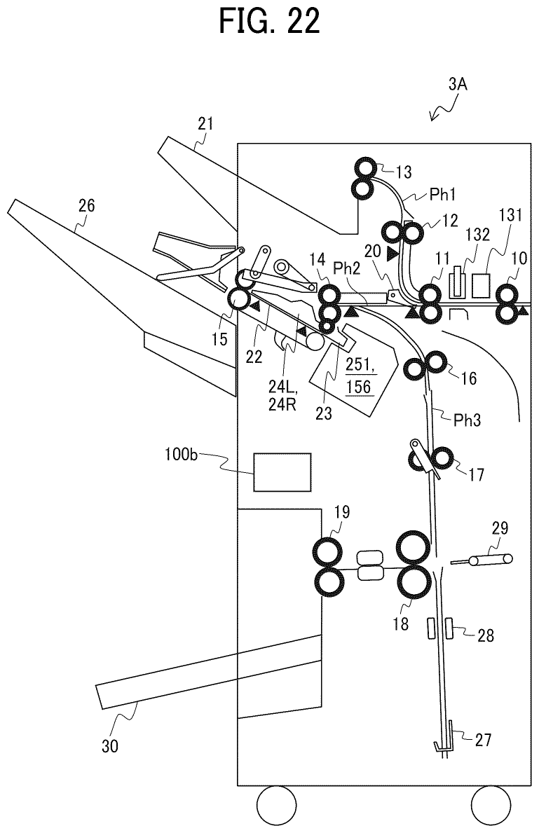

A description is given of a post-processing apparatus 3A according to a second embodiment, with reference to FIGS. 22 to 30.

Components common to those of the post-processing apparatus 3 according to the first embodiment are attached with the same or like reference signs, and detailed descriptions may be omitted.

An edge binder 251 of the post-processing apparatus 3A according to the second embodiment is different from the edge binder 25 of the post-processing apparatus 3 according to the first embodiment in which the liquid applier 31 and the crimper 32 are arranged side by side, in that the edge binder 251 includes a crimper 32′ only and a liquid applier 131 is disposed on the upstream side in a conveyance passage. Such a configuration allows a given number of sheets P to be stacked after the liquid application process and conveyed to the crimper 32′ of the edge binder 251 disposed at a downstream position of the conveyance passage in the direction in which the sheet P is conveyed. Accordingly, the productivity of the binding process performed by the crimper 32′ is enhanced.

Since the direction in which the conveyance roller pairs 10, 11, and 14 convey the sheet P is opposite to the “conveyance direction” defined above, the direction in which the conveyance roller pairs 10, 11, and 14 convey the sheet P is defined as a “reverse conveyance direction” in the following description. A direction that is orthogonal to both the reverse conveyance direction and the thickness direction of the sheet P is defined as the “main scanning direction” or the “width direction of the sheet P”. The liquid application position on a sheet P or a sheet bundle Pb onto which liquid application is performed by the liquid applier 131 corresponds to the binding position on the sheet bundle Pb to be crimped and bound by the crimper 32′. For this reason, in the following description, the liquid application position and the binding position are denoted by the same reference sign (B1).

FIG. 22 is a diagram illustrating an internal structure of the post-processing apparatus 3A according to the second embodiment.

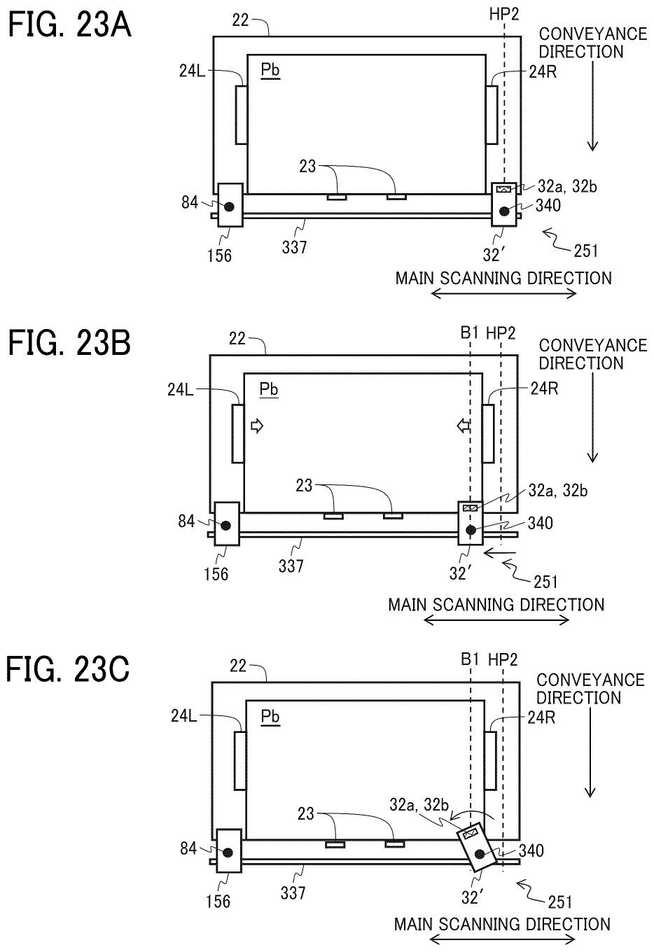

Each of FIGS. 23A, 23B, and 23C is a schematic view of the internal tray 22 in the thickness direction of the sheet bundle Pb.

As illustrated in FIGS. 23A, 23B, and 23C, the edge binder 251 includes only the crimper 32′. As illustrated in FIGS. 23A, 23B, and 23C, the crimper 32′ and the staple binder 156 are disposed downstream from the internal tray 22 in the conveyance direction. The crimper 32′ and the staple binder 156 are located to face a downstream end, in the conveyance direction, of the sheet bundle Pb placed on the internal tray 22 and is movable in the main scanning direction.

The crimper 32′ and the staple binder 156 are respectively rotatable in the forward and reverse directions about a crimper shaft 340 and a stapler shaft 84 both extending in the thickness direction of the sheet bundle Pb placed on the internal tray 22. In other words, the crimper 32′ and the staple binder 156 bind, at a desired angle, a desired position in the main scanning direction on the sheet bundle Pb placed on the internal tray 22 in, for example, corner oblique binding, parallel one-point binding, or parallel two-point binding.

The crimper 32′ presses and deforms the sheet bundle Pb with the serrate upper crimping teeth 32a and the serrate lower crimping teeth 32b to bind the sheet bundle Pb (hereinafter denoted as “crimp binding”). On the other hand, the staple binder 156 passes the staple through a binding position on the sheet bundle Pb placed on the internal tray 22 to staple the sheet bundle Pb.

As illustrated in FIGS. 23A, 23B, and 23C, the crimper 32′ and the staple binder 156 are disposed downstream from the internal tray 22 in the conveyance direction. The crimper 32′ is movable in the main scanning direction along the surface of the sheet bundle Pb placed on the internal tray 22. The crimper 32′ is rotatable in the forward and reverse directions about the crimper shaft 340 extending in the thickness direction of the sheet bundle Pb placed on the internal tray 22.

Similarly, the staple binder 156 is movable in the main scanning direction of the sheet bundle Pb. The staple binder 156 is rotatable in the forward and reverse directions about the stapler shaft 84 extending in thickness direction of the sheet bundle Pb. Since the other components of the staple binder 156 are similar to those of the staple binder 155 (see FIG. 6) of the post-processing apparatus 3 according to the first embodiment, a detailed description thereof is omitted.

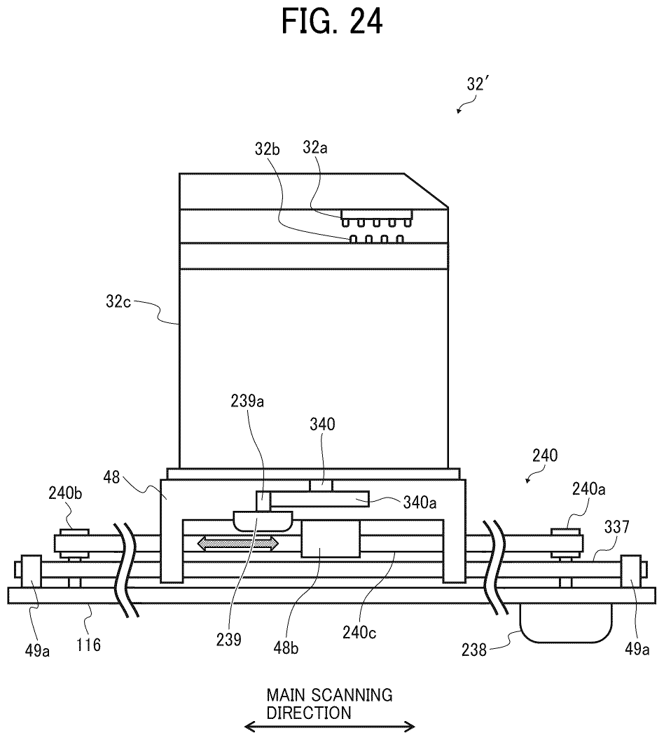

FIG. 24 is a schematic view of a downstream side of the crimper 32′ in the conveyance direction.

As illustrated in FIG. 24, the crimper 32′ includes a guide rail 337 extending in the main scanning direction at a position downstream from the internal tray 22 in the conveyance direction. The crimper 32′ includes a crimper movement motor 238 as a driving source. The base 48 supporting the crimping frame 32c has a fastening portion 48b for fastening a timing belt 240c at the bottom of the base 48. The driving force of the crimper movement motor 238 is transmitted to the base 48 by a drive transmission assembly 240 that includes pullies 240a and 240b, the timing belt 240c, and the fastening portion 48b. By so doing, the crimper 32′ is moved in the main scanning direction along the surface of the sheet bundle Pb placed on the internal tray 22, in other words, along the guide rail 337. A crimper shaft 340 including a drive transmission gear 340a is fixed to a bottom face of the crimping frame 32c that holds the components of the crimper 32′.

The crimper shaft 340 and the drive transmission gear 340a are held by the base 48 on which the crimping frame 32c is disposed, so as to be rotatable in the forward and reverse directions. The drive transmission gear 340a meshes with an output gear 239a of a crimper pivot motor 239. When the driving force of the crimper pivot motor 239 is transmitted to the crimper shaft 340 via the output gear 239a and the drive transmission gear 340a, the crimper 32′ rotates in the forward and reverse directions on the base 48 about the crimper shaft 340 extending in the thickness direction of the sheet P placed on the internal tray 22. The guide rail 337, the crimper movement motor 238, the crimper pivot motor 239, the crimper shaft 340, and the drive transmission assembly 240 form at least part of a driving assembly of the crimper 32′ according to the present embodiment.

The crimper 32′ moves between the standby position HP2 illustrated in FIG. 23A and a position where the crimper 32′ faces the first binding position B1 illustrated in FIGS. 23B and 23C. The standby position HP2 is a position deviated to one side in the main scanning direction from the sheet bundle Pb stacked on the internal tray 22. The first binding position B1 is a position on the sheet bundle Pb placed on the internal tray 22. However, the specific position of the first binding position B1 is not limited to the example of FIGS. 23A, 23B, and 23C, and may be any position in the main scanning direction at the downstream end in the conveyance direction of the sheet P, and may be multiple positions.

The posture of the crimper 32′ changes between a parallel binding posture illustrated in FIG. 23B and an oblique binding posture illustrated in FIG. 23C. In other words, the crimper 32′ is rotatable in the forward and reverse directions about the crimper shaft 340. The parallel binding posture is a posture of the crimper 32′ in which the longitudinal direction of the upper crimping teeth 32a and the lower crimping teeth 32b (in other words, a rectangular crimp binding trace) is along the main scanning direction. The inclined binding posture is a posture of the crimper 32′ in which the longitudinal direction of the upper crimping teeth 32a and the lower crimping teeth 32b (in other words, a rectangular crimp binding trace) is inclined with respect to the main scanning direction.

The rotational angle, which is an angle of the upper crimping teeth 32a and the lower crimping teeth 32b with respect to the main scanning direction, in the oblique binding posture is not limited to the angle illustrated in FIG. 23C. The rotational angle in the oblique binding posture may be any angle provided that the upper crimping teeth 32a and the lower crimping teeth 32b face the sheet bundle Pb placed on the internal tray 22.

The post-processing apparatus 3A includes the liquid applier 131 and a hole punch 132. The liquid applier 131 and the hole punch 132 are disposed upstream from the internal tray 22 in the reverse conveyance direction. The liquid applier 131 and the hole punch 132 are disposed at different positions in the reverse conveyance direction to simultaneously face one sheet P that is conveyed by the conveyance roller pairs 10 to 19.

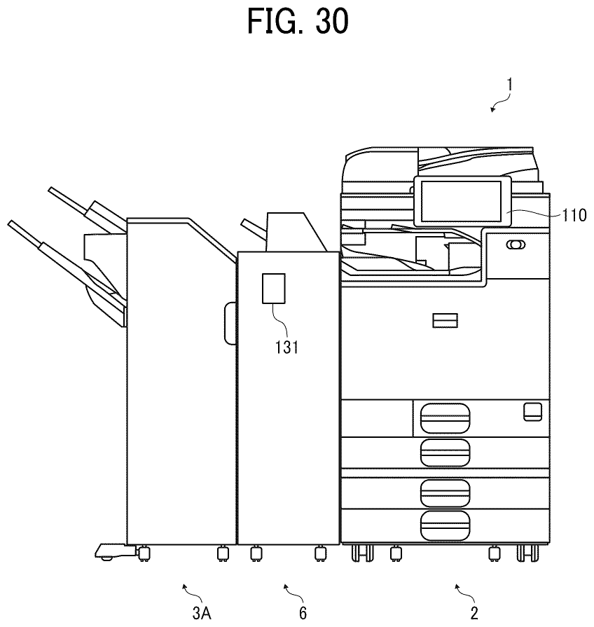

The liquid applier 131 and the hole punch 132 according to the present embodiment are disposed between the conveyance roller pairs 10 and 11. However, the arrangement of the liquid applier 131 is not limited to the example of FIG. 22. For example, in a case where an inserter 6 is disposed between the image forming apparatus 2 and the post-processing apparatus 3A as illustrated in FIG. 30, the liquid applier 131 may be disposed inside the inserter 6 located upstream from the post-processing apparatus 3A. Examples of the inserter 6 include, but are not limited to, an apparatus that allows a pre-printed medium, which is to be conveyed to the post-processing apparatus 3A together with the sheet P conveyed from the image forming apparatus 2, to be fed as a cover sheet, an insertion sheet, or a partition sheet without passing through the image forming apparatus 2.

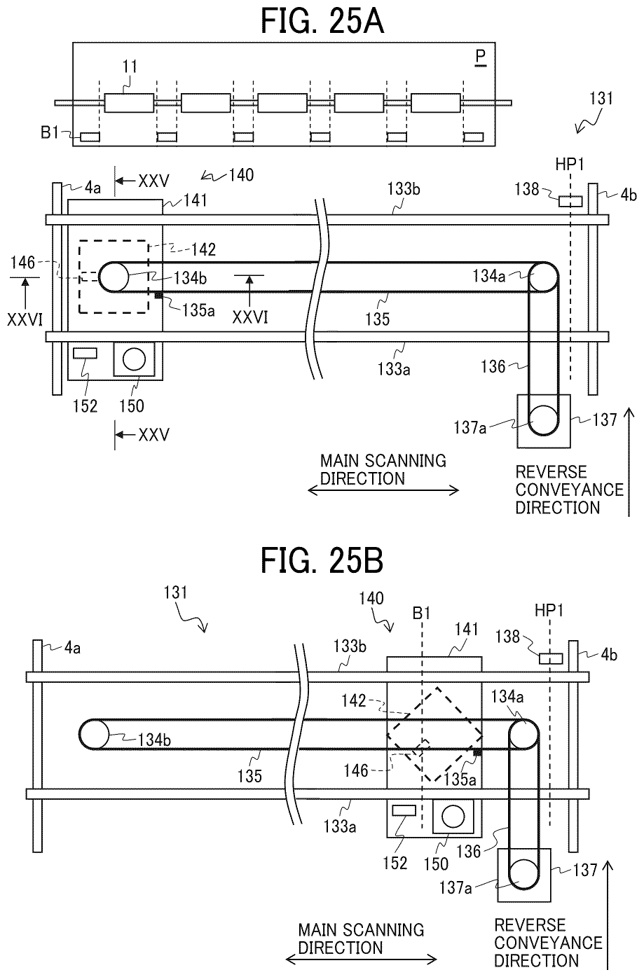

As illustrated in FIG. 25A, the conveyance roller pair 11 is located at a position at which the conveyance roller pair 11 does not overlap, in the main scanning direction, with the first liquid application position B1 on the sheet P to which liquid has been applied by a liquid application head 146 of the liquid applier 131. This arrangement is to prevent the amount of liquid at the first liquid application position B1 from decreasing due to multiple roller pairs pressing the first liquid application position B1 when the conveyance roller pair 11 conveys the sheet P. As a result, when the sheet P reaches the crimper 32′ disposed downstream from the liquid applier 131 in the reverse conveyance direction, the amount of liquid at the first liquid application position B1 is sufficient to maintain the binding strength. Accordingly, the binding strength of the sheet bundle Pb is prevented from decreasing due to a decrease in the amount of liquid at the first liquid application position B1 (corresponding to the first binding position B1) while the sheet P is conveyed.

In addition, multiple rollers of the conveyance roller pair 11 are located at positions at which the multiple roller pairs do not overlap with the first liquid application position B1 on the sheet P in the main scanning direction, which can thus prevent the conveying performance of the sheet P from being worse due to the adhesion of liquid to the roller pairs and further prevent a conveyance jam caused by the worsened conveying performance of the sheet P.

Although only the conveyance roller pair 11 has been described above, similarly, the roller pairs of the conveyance roller pairs 14 and 15 are also preferably located at positions at which the roller pairs do not overlap with the first liquid application position B1 on the sheet P in the main scanning direction.

The liquid applier 131 applies liquid to the sheet P that is conveyed by the conveyance roller pairs 10 and 11. In the following description, the application of liquid may be referred to as “liquid application”. The hole punch 132 punches a hole in the sheet P that is conveyed by the conveyance roller pairs 10 and 11 such that the hole passes through the sheet P in the thickness direction of the sheet P. The processor disposed near the liquid applier 131 is not limited to the hole punch 132. Alternatively, the processor may be an inclination corrector that corrects an inclination or skew of the sheet P that is conveyed by the conveyance roller pairs 10 and 11.

FIGS. 25A and 25B are schematic views of the liquid applier 131 according to the second embodiment, viewed from the thickness direction of the sheet P.

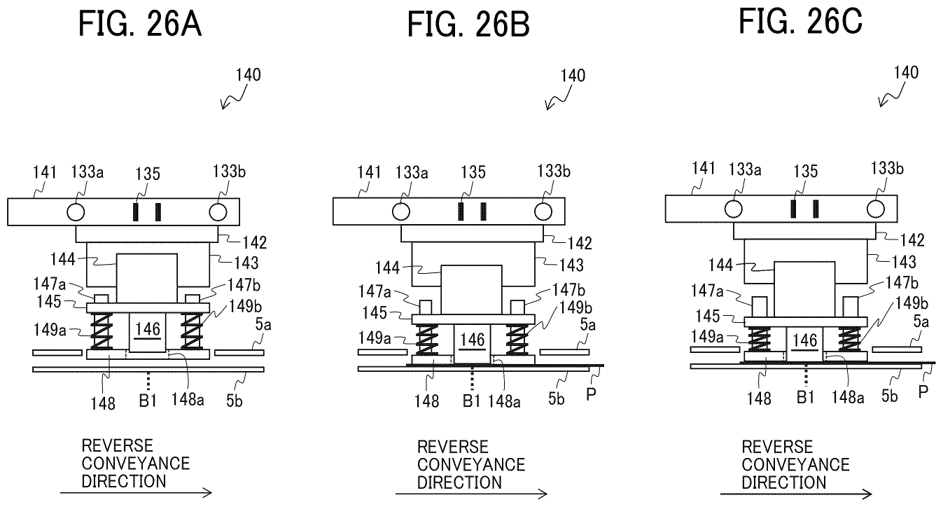

FIGS. 26A, 26B, and 26C are cross-sectional views taken along XXV-XXV of FIG. 25A.

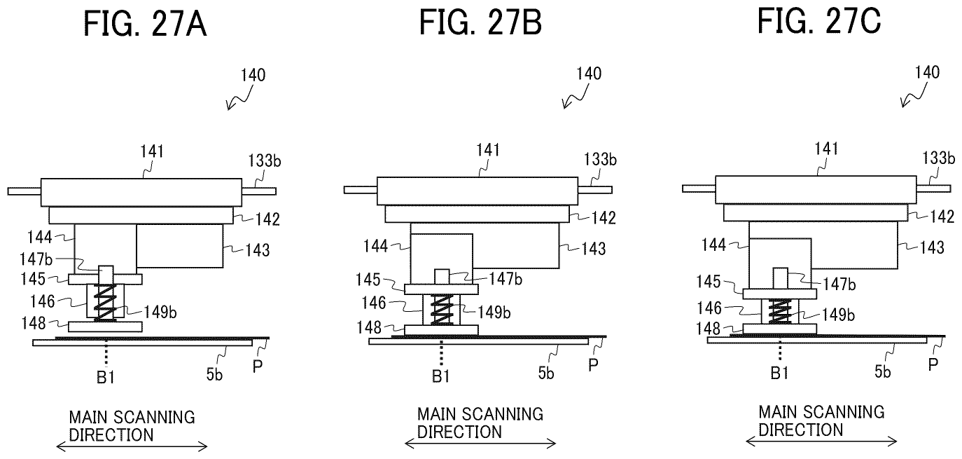

FIGS. 27A, 27B, and 27C are cross-sectional views taken along XXVI-XXVI of FIG. 25A.

As illustrated in FIGS. 25A to 27C, the liquid applier 131 includes a pair of guide shafts 133a and 133b, a pair of pulleys 134a and 134b, endless annular belts 135 and 136, a liquid applier movement motor 137, a standby position sensor 138, and a liquid application unit 140.

The guide shafts 133a and 133b, each extending in the main scanning direction, are spaced apart from each other in the reverse conveyance direction. The pair of guide shafts 133a and 133b are supported by a pair of side plates 4a and 4b of the post-processing apparatus 3A. The pair of guide shafts 133a and 133b support the liquid application unit 140 such that the liquid application unit 140 can move in the main scanning direction.

The pair of pulleys 134a and 134b is disposed between the pair of guide shafts 133a and 133b in the reverse conveyance direction. The pair of pulleys 134a and 134b is spaced apart from each other in the main scanning direction. The pair of pulleys 134a and 134b is supported by a frame of the post-processing apparatus 3A so as to be rotatable in the forward and reverse directions about the respective shafts extending in the thickness direction of the sheet P.

The endless annular belt 135 is looped around the pair of pulleys 134a and 134b. The endless annular belt 135 is coupled to the liquid application unit 140 by a coupling portion 135a. The endless annular belt 136 is entrained around the pulley 134a and a driving pulley 137a that is fixed to an output shaft of the liquid applier movement motor 137. The liquid applier movement motor 137 generates a driving force to move the liquid application unit 140 in the main scanning direction.

As the liquid applier movement motor 137 rotates, the endless annular belt 136 circulates around the pulley 134a and the driving pulley 137a to rotate the pulley 134a. As the pulley 134a rotates, the endless annular belt 135 circulates around the pair of pulleys 134a and 134b. As a result, the liquid application unit 140 moves in the main scanning direction along the pair of guide shafts 133a and 133b. The liquid application unit 140 reciprocates in the main scanning direction in response to switching of the rotation direction of the liquid applier movement motor 137.

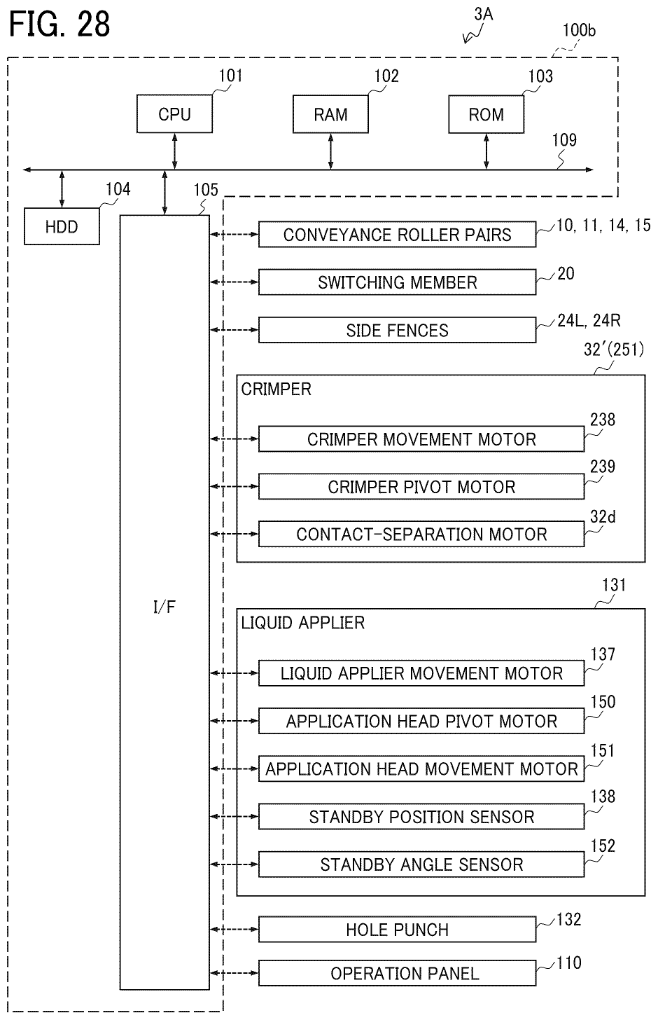

The standby position sensor 138 detects that the liquid application unit 140 has reached a standby position HP1 in the main scanning direction (see FIGS. 25A and 25B), and outputs a standby position signal indicating a detection result to a controller 100b to be described later (see FIG. 28). The standby position sensor 138 is, for example, an optical sensor including a light emitter and a light receiver. At the standby position HP1, the liquid application unit 140 blocks the optical path between the light emitter and the light receiver. The standby position sensor 138 outputs the standby position signal in response to the light output from the light emitter not being received by the light receiver. The specific configuration of the standby position sensor 138 is not limited to the configuration described above.

As illustrated in FIGS. 26A, 26B, and 26C, the conveyance passage inside the post-processing apparatus 3A is defined by an upper guide plate 5a and a lower guide plate 5b, which are apart from each other in the thickness direction of the sheet P. The liquid application unit 140 is located to face an opening of the upper guide plate 5a. In other words, the liquid application unit 140 is disposed to face the conveyance passage (in other words, a position at which the liquid application unit 140 can face the sheet P) through the opening of the upper guide plate 5a.

As illustrated in FIGS. 25A to 27C, the liquid application unit 140 includes a base 141, a rotary bracket 142, a liquid storage tank 143, a liquid-application-head mover 144, a holder 145, the liquid application head 146, columns 147a and 147b, a pressure plate 148, coil springs 149a and 149b, an application head pivot motor 150, an application head movement motor 151 (see FIG. 28), and a standby angle sensor 152 (see FIG. 28).

The base 141 is supported by the pair of guide shafts 133a and 133b so as to be slidable in the main scanning direction. The base 141 is coupled to the endless annular belt 135 by the coupling portion 135a. The base 141 supports the components (including the rotary bracket 142 to the standby angle sensor 152) of the liquid application unit 140.

The rotary bracket 142 is attached to the lower face of the base 141 so as to be rotatable in the forward and reverse directions about an axis extending in the thickness direction of the sheet P. The rotary bracket 142 is rotated with respect to the base 141 by a driving force transmitted from the application head pivot motor 150. The rotary bracket 142 retains the liquid storage tank 143, the liquid-application-head mover 144, the holder 145, the liquid application head 146, the columns 147a and 147b, the pressure plate 148, and the coil springs 149a and 149b.

The standby angle sensor 152 (see FIG. 28) detects that the rotary bracket 142 has reached a standby angle. The standby angle sensor 152 then outputs a standby angle signal indicating the detection result to the controller 100b. The standby angle is, for example, an angle at the time of performing parallel binding. The standby angle sensor 152 is, for example, an optical sensor including a light emitter and a light receiver. The rotary bracket 142 at the standby angle blocks an optical path between the light emitter and the light receiver. The standby angle sensor 152 outputs the standby angle signal in response to the light output from the light emitter not being received by the light receiver. The specific configuration of the standby angle sensor 152 is not limited to the configuration described above.

FIG. 25A illustrates the rotary bracket 142 in a position for the parallel binding that is performed by the crimper 32′ disposed downstream from the liquid applier 131.

FIG. 25B illustrates the rotary bracket 142 in a position for the oblique binding (i.e., corner binding) that is performed by the crimper 32′ disposed downstream from the liquid applier 131.

The liquid storage tank 143 stores liquid to be applied to the sheet P. The liquid-application-head mover 144 is attached by the liquid storage tank 143 so as to be movable (e.g., up and down) in the thickness direction of the sheet P. The liquid-application-head mover 144 is moved with respect to the liquid storage tank 143 by a driving force transmitted from the application head movement motor 151. The holder 145 is attached to a lower end of the liquid-application-head mover 144. The liquid application head 146 projects from the holder 145 toward the conveyance passage (downward in the present embodiment). The liquid that is stored in the liquid storage tank 143 is supplied to the liquid application head 146. The liquid application head 146 is made of a material having a relatively high liquid absorption (e.g., sponge or fiber).

The columns 147a and 147b project downward from the holder 145 around the liquid application head 146. The columns 147a and 147b are movable relative to the holder 145 in the thickness direction. The columns 147a and 147b have respective lower ends holding the pressure plate 148. The pressure plate 148 has a through hole 148a at a position where the through hole 148a faces the liquid application head 146. The coil springs 149a and 149b are fitted around the columns 147a and 147b, respectively, between the holder 145 and the pressure plate 148. The coil springs 149a and 149b bias the columns 147a and 147b and the pressure plate 148 in a direction away from the holder 145.

As illustrated in FIGS. 26A and 27A, before the sheet P is conveyed to the position where the sheet P faces the opening of the upper guide plate 5a, the pressure plate 148 is positioned at or above the opening. Subsequently, when the sheet P that is conveyed by the conveyance roller pairs 10 and 11 stops at a position where the first liquid application position B1 on the sheet P faces the opening, the application head movement motor 151 is rotated in a first direction. As a result, the liquid-application-head mover 144, the holder 145, the liquid application head 146, the columns 147a and 147b, the pressure plate 148, and the coil springs 149a and 149b move down together, and the pressure plate 148 contacts the sheet P. The first liquid application position B1 is a position (in other words, the first binding position B1) to be crimped and bound by the edge binder 251 (in other words, the crimper 32′).

As the application head movement motor 151 keeps rotating in the first direction after the pressure plate 148 contacts the sheet P, the coil springs 149a and 149b are compressed to further move down the liquid-application-head mover 144, the holder 145, the liquid application head 146, and the columns 147a and 147b. As a result, as illustrated in FIGS. 26B and 27B, a lower face of the liquid application head 146 contacts the sheet P through the through hole 148a. As a result, the liquid contained in the liquid application head 146 is applied to the sheet P.

Further rotation of the application head movement motor 151 in the first direction further strongly presses the liquid application head 146 against the sheet P as illustrated in FIGS. 26C and 27C. Accordingly, the amount of liquid that is applied to the sheet P increases. In other words, the liquid applier 131 changes the pressing force of the liquid application head 146 against the sheet P to adjust the amount of liquid that is applied to the sheet P.

On the other hand, the rotation of the application head movement motor 151 in the second direction opposite to the first direction moves up the liquid-application-head mover 144, the holder 145, the liquid application head 146, the columns 147a and 147b, the pressure plate 148, and the coil springs 149a and 149b together. As a result, as illustrated in FIGS. 26A and 27A, the liquid application head 146 and the pressure plate 148 are separated from the sheet P. In other words, the liquid applier 131 includes the liquid application head 146 that can be separated from the sheet P.

FIG. 28 is a hardware configuration diagram of a control block to control the operation of the post-processing apparatus 3A according to the second embodiment.

As illustrated in FIG. 28, the post-processing apparatus 3A includes a configuration in which a central processing unit (CPU) 101, a random access memory (RAM) 102, a read only memory (ROM) 103, a hard disk drive (HDD) 104, and an interface (I/F) 105 are connected to each other via a common bus 109.

The CPU 101 is an arithmetic unit and controls the overall operation of the post-processing apparatus 3A.

The RAM 102 is a volatile storage medium that allows data to be read and written at high speed. The CPU 101 uses the RAM 102 as a working area for data processing.

The ROM 103 is a read-only non-volatile storage medium that stores programs such as firmware.

The HDD 104 is a non-volatile storage medium that allows data to be read and written and has a relatively large storage capacity. The HDD 104 stores, e.g., an operating system (OS), various control programs, and application programs.

By an arithmetic function of the CPU 101, the post-processing apparatus 3A processes, for example, a control program stored in the ROM 103 and an information processing program (application program) loaded into the RAM 102 from a storage medium such as the HDD 104. Such processing configures a software controller including various functional modules of the post-processing apparatus 3A. The software controller thus configured cooperates with hardware resources of the post-processing apparatus 3A to construct functional blocks that implement functions of the post-processing apparatus 3A. In other words, the CPU 101, the RAM 102, the ROM 103, the HDD 104, and the I/F 105 form at least part of a controller 100b (control unit) that controls the operation of the post-processing apparatus 3A.

The I/F 105 is an interface that connects the conveyance roller pairs 10, 11, 14, and 15, the switching member 20, the side fences 24L and 24R, the crimper movement motor 238, the crimper pivot motor 239, the contact-separation motor 32d, the liquid applier movement motor 137, the application head pivot motor 150, the application head movement motor 151, the standby position sensor 138, the standby angle sensor 152, the hole punch 132, and an operation panel 110 to the common bus 109.

The controller 100b controls, via the I/F 105, the operations of the conveyance roller pairs 10, 11, 14, and 15, the switching member 20, the side fences 24L and 24R, the crimper movement motor 238, the crimper pivot motor 239, the contact-separation motor 32d, the liquid applier movement motor 137, the application head pivot motor 150, the application head movement motor 151, and the hole punch 132. The controller 100b acquires detection results from the standby position sensor 138 and the standby angle sensor 152 through the I/F 105.

Although FIG. 28 mainly illustrates the components of the edge binder 251 (the crimper 32′) that executes the edge binding and the liquid applier 131, the components of the saddle binder 28 that executes saddle binding are controlled by the controller 100b in a similar manner.

As illustrated in FIG. 30, the image forming apparatus 2 includes the operation panel 110. The operation panel 110 includes an operation unit that receives instructions input by a user and a display serving as a notifier that notifies the user of information. The operation unit includes, for example, physical input buttons and a touch screen overlaid on a display. The operation panel 110 acquires information from the user through the operation unit and provides information to the user through the display. The post-processing apparatus 3A may include the operation panel 110 similar to the above-described operation panel 110.

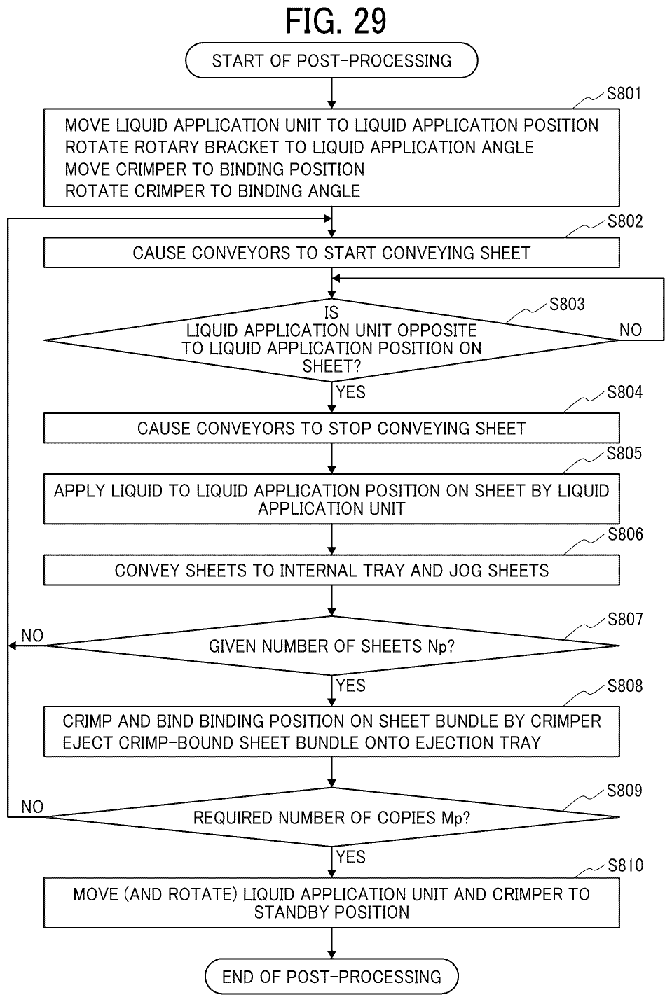

FIG. 29 is a flowchart of post-processing of the post-processing apparatus 3A according to the second embodiment.

Specifically, FIG. 29 is a flowchart of a process in executing the one-point binding illustrated in FIGS. 23A to 23C.

For example, the controller 100b executes the post-processing illustrated in FIG. 29 in response to acquisition of an instruction (denoted below as “post-processing command”) of executing the post-processing from the image forming apparatus 2. The post-processing command includes, for example, the number of sheets P of the sheet bundle Pb (denoted below as “given number of sheets Np”), the number of sheet bundles Pb to be subjected to binding process (denoted below as “requested number of sheets Mp”), the first binding position B1 (corresponding to the first liquid application position B1), the angle of the first binding position B1 (corresponding to the angle of the first liquid application position B1), the type of binding process (parallel binding process or oblique binding process), and a process that is executed in parallel with the liquid application process (punching a hole in the present embodiment). At the start of the post-processing, the liquid application unit 140 is at the standby position HP1 (see FIGS. 25A and 25B), and the rotary bracket 142 is held at the standby angle (corresponding to “parallel binding posture”).

First, the controller 100b drives the liquid applier movement motor 137 to move the liquid application unit 140 (corresponding to the liquid applier) in the main scanning direction, so that the liquid application head 146 moves from the standby position HP1 to a position where the liquid application head 146 faces the first liquid application position B1 (see FIG. 25B, and a position corresponding to the first binding position B1 in FIGS. 23B and 23C). If the type of the binding process instructed by the post-processing command is “oblique binding process”, in step S801, the controller 100b drives the application head pivot motor 150 to rotate the rotary bracket 142. Thus, the liquid application head 146 is rotated from the standby angle to the liquid application angle corresponding to the “oblique binding posture”. It can be ascertained, based on pulse signals output from rotary encoders of the liquid applier movement motor 137 and the application head pivot motor 150, that the liquid application head 146 has reached the position where the liquid application head 146 can face the first liquid application position B1 and has reached the liquid application angle. In a case where the type of the binding process instructed by the post-processing command is “parallel binding process”, the controller 100b omits the above-described operation of rotating the rotary bracket 142. In other words, the liquid application unit 140 moves in the main scanning direction while holding the rotary bracket 142 at the standby angle.

The controller 100b also drives the crimper movement motor 238 to move the crimper 32′ from the standby position HP2 to the position where the crimper 32′ can face the first binding position B1 as illustrated in FIGS. 23A and 23B (step S801). If the type of the binding process instructed by the post-processing command is “oblique binding process”, the controller 100b drives the crimper pivot motor 239 to rotate the crimper 32′ from the standby angle to the crimping angle corresponding to the “oblique binding posture” (step S801). It can be ascertained, based on pulse signals output from rotary encoders of the crimper movement motor 238 and the crimper pivot motor 239, that the crimper 32′ has reached the position where the crimper 32′ can face the first binding position B1. In a case where the type of the binding process instructed by the post-processing command is “parallel binding process”, the controller 100b omits the above-described operation of rotating the crimper 32′. In other words, the crimper 32′ moves in the main scanning direction while maintaining the standby angle.

Subsequently, the controller 100b drives the conveyance roller pairs 10 and 11 to start conveying the sheet P on which an image is formed by the image forming apparatus 2 (step S802). The controller 100b determines whether the first liquid application position B1 on the sheet P has faced the liquid application unit 140 (more particularly, the liquid application head 146) (step S803). When the controller 100b determines that the first liquid application position B1 on the sheet P has not faced the liquid application unit 140 (NO in step S803), the controller 100b continues causing the conveyance roller pairs 10 and 11 to convey the sheet P until the first liquid application position B1 on the sheet P faces the liquid application unit 140 (YES in step S803). When the controller 100b determines that the first liquid application position B1 on the sheet P has faced the liquid application head 146 (YES in step S803), the controller 100b causes the conveyance roller pairs 10 and 11 to stop conveying the sheet P (step S804). It can be ascertained, based on a pulse signal output from a rotary encoder of a motor that drives the conveyance roller pairs 10 and 11, that the first liquid application position B1 on the sheet P has faced the liquid application head 146.

The controller 100b causes the liquid application unit 140 to execute the process of applying liquid to the first liquid application position B1 on the sheet P (step S805). More particularly, the controller 100b rotates the application head movement motor 151 in the first direction to bring the liquid application head 146 into contact with the first liquid application position B1 on the sheet P. The controller 100b changes the pressing force of the liquid application head 146 (in other words, the amount of rotation or rotation speed of the application head movement motor 151) depending on the amount of liquid to be applied to the sheet P.

The amount of liquid that is applied to the sheet P may be the same for all the sheets P of the sheet bundle Pb or may be different for each sheet P. For example, the controller 100b may decrease the amount of liquid applied to a sheet P conveyed later. The amount of rotation of the application head movement motor 151 may be ascertained based on a pulse signal outputted from a rotary encoder of the application head movement motor 151.

The controller 100b drives the conveyance roller pairs 10, 11, 14, and 15 to place a sheet P on the internal tray 22 (step S806). In addition, the controller 100b moves the side fences 24L and 24R in the main scanning direction to align the positions of the in the main scanning direction of the sheet P or the sheet bundle Pb stacked on the internal tray 22, in other words, execute so-called jogging process (step S806).

The controller 100b determines whether the number of sheets P placed on the internal tray 22 has reached the given number of sheets Np indicated by the post-processing command (step S807). When the controller 100b determines that the number of sheets P placed on the internal tray 22 has not reached the given number of sheets Np (NO in step S807), the controller 100b executes the operations of steps S802 to S807 again until the number of sheets P placed on the internal tray 22 reaches the given number of sheets Np (YES in step S807).

On the other hand, when the controller 100b determines that the number of sheets P that are placed on the internal tray 22 has reached the given number of sheets Np (YES in step S807), the controller 100b causes the crimper 32′ to crimp the first binding position B1 (corresponding to the first liquid application position B1) on the sheet bundle Pb to which the liquid has been applied by the liquid application unit 140 (step S808). The controller 100b also rotates the conveyance roller pair 15 to eject the crimped and bound sheet bundle Pb to the second ejection tray 26 (step S808).

The controller 100b determines whether the number of sheet bundles Pb thus ejected to the second ejection tray 26 has reached the requested number of copies Mp indicated by the post-processing command (step S809). When the controller 100b determines that the number of the sheet bundles Pb ejected to the second ejection tray 26 has not reached the requested number of copies Mp (NO in step S809), the controller 100b repeats the processing of steps S802 to S809 until the number of the sheet bundles Pb ejected to the second ejection tray 26 reaches the requested number of copies Mp (YES in step S809).

When the controller 100b determines that the number of sheet bundles Pb ejected to the second ejection tray 26 reaches the requested number of copies Mp (YES in step S809), the controller 100b drives the liquid applier movement motor 137 to move the liquid application unit 140 to the standby position HP1 (see FIGS. 25A and 25B) and drives the crimper movement motor 238 to move the crimper 32′ to the standby position HP2 (see FIGS. 23A to 23C) (step S810). When the posture that is instructed by the post-processing operation is the “oblique binding posture”, the controller 100b drives the application head pivot motor 150 and the crimper pivot motor 239 to rotate the liquid application unit 140 and crimper 32′ and the parallel binding posture (standby angle) into the parallel binding posture (step S810). On the other hand, when the posture that is instructed by the post-processing command is the “parallel binding posture”, the operation of rotating the liquid application unit 140 and the crimper 32′ to the parallel binding posture (standby angle) is skipped. In steps S801 and S810, the execution order of the movement in the main scanning direction and the rotation in the forward and reverse directions of the liquid application unit 140 and the crimper 32′ is not limited to the aforementioned order and may be reversed.

The present disclosure can be applied to not only the edge binder 25 that executes edge binding process but also to the saddle binder 28 that executes saddle binding process.

The configuration in which the controller 100b of the post-processing apparatus 3A according to the second embodiment illustrated in FIG. 22 is provided separately from the controller 100a of the image forming apparatus 2 similarly with FIG. 1 has been described, but it is not limited to such a configuration. For example, as illustrated in FIG. 31A, the controller 100b of the post-processing apparatus 3A may be disposed in the image forming apparatus 2. As in the configuration of FIG. 31B, the controller 100b of the post-processing apparatus 3A may be integrated with the controller 100a of the image forming apparatus 2.

As in the configuration of FIG. 32A, the controller 100b of the post-processing apparatus 3A may be divided into a controller 100b1 (e.g., a driver system such as a motor) and a controller 100b2 (detector such as a sensor) according to the function, and the controller 100b2 of the post-processing apparatus 3A may be disposed on the side of the image forming apparatus 2. As in the configuration of FIG. 32B, the controller 100b2 of the post-processing apparatus 3A disposed in the image forming apparatus 2 may be integrated with the controller 100a of the image forming apparatus 2.

As described above, the control method by the controller 100b described above is implemented by cooperation between hardware resources of a computer and a program as computer software. In other words, the control method may be a method executed by a computer causing an arithmetic device, a storage device, an input device, an output device, and a control device to operate in cooperation with each other based on a program. The program may be written in, for example, a storage device or a storage medium and distributed, or may be distributed through, for example, an electric communication line.

Embodiments of the present disclosure are not limited to the above-described embodiments, and numerous additional modifications and variations are possible in light of the teachings. The technical contents included in the technical ideas described in the appended claims are included within the scope of the present disclosure. The above-described embodiments represent examples, and various modifications can be achieved by those skilled in the art from the disclosed contents. Such modifications are also included in the technical scope of the present disclosure.

Aspects of the present disclosure are, for example, as follows.

### Aspect 1

In Aspect 1, a medium processing apparatus includes a first tray, a liquid applier, a crimper, and a controller. The liquid applier applies liquid to at least one medium supported by the first tray. The crimper crimps and binds multiple media to which the liquid is applied by the liquid applier. The controller controls operations of the liquid applier and the crimper. The controller measures an elapsed time after the liquid applier applies the liquid to a first medium, causes the crimper to crimp and bind a medium bundle including the first medium and a second medium subsequent to the first medium without reapplying the liquid to the first medium when the second medium is supplied to the first tray before the elapsed time reaches a threshold time, and causes reapplication of the liquid to the first medium and causing the crimper to crimp and bind the medium bundle when the elapsed time reaches the threshold time until the second medium is supplied to the first tray.

### Aspect 2

In Aspect 2, in the medium processing apparatus according to Aspect 1, the controller adjusts the threshold time based on at least one of a type of the first medium, a thickness of the first medium, a humidity of an installation place of the medium processing apparatus, a room temperature of the installation place of the medium processing apparatus, or a number of the media supported by the first tray.

### Aspect 3

In Aspect 3, in the medium processing apparatus according to Aspect 1 or Aspect 2, the controller adjusts an amount of the liquid to be reapplied to the first medium based on at least one of a type of the first medium, a thickness of the first medium, a number of the media supported by the first tray, or a length of the elapsed time.

### Aspect 4

In Aspect 4, in the medium processing apparatus according to Aspect 3, the liquid applier applies liquid by pressing a liquid application member containing liquid against the medium supported by the first tray, and the controller adjusts the amount of the liquid to be reapplied to the first medium by increasing or decreasing a pressing time of the liquid application member.

### Aspect 5

In Aspect 5, the medium processing apparatus according to any one of Aspects 1 to 4 further includes a second tray. When the elapsed time reaches the threshold time until the second medium is supplied to the first tray, the controller determines whether to reapply the liquid to the first medium or to discharge the medium supported by the first tray to the second tray without crimping and binding the medium.

### Aspect 6

In Aspect 6, in the medium processing apparatus according to Aspect 5, the controller determines whether to reapply the liquid to the first medium or to discharge the medium supported by the first tray to the second tray without crimping and binding the medium based on at least one of a type of the first medium, a thickness of the first medium, a number of the media supported by the first tray, an amount of the liquid contained in the first medium, or a number of times of reapplying the liquid to the medium supported by the first tray.

### Aspect 7

In Aspect 7, the medium processing apparatus according to Aspect 5 further includes an operation unit configured to receive an operation of a user. The controller determines whether to reapply the liquid to the first medium or discharge the medium supported on the first tray to the second tray without crimping and binding the media based on the operation of the user through the operation unit.

### Aspect 8

In Aspect 8, in the medium processing apparatus according to any one of Aspects 1 to 7, when the elapsed time reaches the threshold time until the second medium is supplied to the first tray, the controller reapplies the liquid to the first medium in response to the second medium becoming suppliable to the first tray.

### Aspect 9

In Aspect 9, an image forming system includes an image forming apparatus configured to form an image on a medium, and the medium processing apparatus according to any one of Aspects 1 to 8.

### Aspect 10

In Aspect 10, in the image forming system according to Aspect 9, the controller notifies the image forming apparatus of a timing at which the elapsed time reaches the threshold time until the second medium is supplied to the first tray and a timing at which reapplication of the liquid to the first medium is completed.

### Aspect 11

In Aspect 11, a medium processing apparatus includes a tray, a liquid applier, a crimper, and circuitry. The liquid applier applies liquid to a medium supported by the tray as an application process. The crimper crimps and binds a media bundle including the medium to which the liquid is applied by the liquid applier as a binding process. The circuitry is to measure an elapsed time after the application process is executed on a first medium of the media bundle, control the liquid applier to reapply the liquid to the first medium as a reapplication process when the elapsed time reaches a threshold time before a second medium subsequent to the first medium is conveyed to the tray, control the liquid applier not to reapply the liquid to the first medium as the reapplication process when the second medium is conveyed to the tray before the elapsed time reaches the threshold time, and control the crimper to execute the binding process on the media bundle including the first medium and the second medium.

### Aspect 12

In Aspect 12, in the medium processing apparatus according to Aspect 11, the circuitry is further to adjust the threshold time based on at least one of a type of the first medium, a thickness of the first medium, a humidity of an installation place of the medium processing apparatus, a room temperature of the installation place of the medium processing apparatus, or a number of media supported by the tray.

### Aspect 13

In Aspect 13, in the medium processing apparatus according to Aspect 11 or Aspect 12, the circuitry is further to adjust an amount of the liquid to be reapplied to the first medium based on at least one of a type of the first medium, a thickness of the first medium, a number of media supported by the tray; or a length of the elapsed time.

### Aspect 14

In Aspect 14, in the medium processing apparatus according to Aspect 13, the liquid applier includes a liquid application member containing the liquid and presses the liquid application member against the medium supported by the tray for a pressing time to execute the application process. The circuitry is further to increase or decrease the pressing time to adjust the amount of the liquid to be reapplied to the first medium.

### Aspect 15

In Aspect 15, the medium processing apparatus according to any one of Aspects 11 to 14 further includes another tray. The circuitry is further to determine whether to execute the reapplication process on the first medium or to eject the medium or the media bundle supported by the tray to said another tray without executing the binding process, when the elapsed time reaches the threshold time before the second medium is conveyed to the tray.

### Aspect 16

In Aspect 16, in the medium processing apparatus according to Aspect 15, the circuitry is further to determine whether to execute the reapplication process on the first medium or to eject the medium or the media bundle supported by the tray to said another tray without executing the binding process, based on at least one of a type of the first medium, a thickness of the first medium, a number of media supported by the tray, an amount of the liquid contained in the first medium, or a number of times of the reapplication process executed on the medium supported by the tray.

### Aspect 17

In Aspect 17, the medium processing apparatus according to Aspect 15 further includes an operation panel to receive an input of an operation. The circuitry is further to determine, based on the input of the operation via the operation panel, whether to execute the reapplication process on the first medium or to eject the medium or the media bundle supported by the tray to said another tray without executing the binding process.

### Aspect 18

In Aspect 18, in the medium processing apparatus according to any one of Aspects 11 to 17, the circuitry is further to reapply the liquid to the first medium in response to the second medium becoming suppliable to the tray, when the elapsed time reaches the threshold time before the second medium is supplied to the tray.

### Aspect 19

In Aspect 19, an image forming system includes an image forming apparatus to form an image on a medium, and the medium processing apparatus according to any one of Aspects 11 to 18.

### Aspect 20

In Aspect 20, in the image forming system according to Aspect 19, the circuitry is further to output a notification to the image forming apparatus at a timing that the elapsed time reaches the threshold time until the second medium is supplied to the tray, and at a timing that reapplication of the liquid to the first medium is completed.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the present disclosure. These novel embodiments can be implemented in various other forms, and various omissions, replacements, or changes can be made without departing from the gist of the present disclosure. These embodiments and their variations are included in the scope and gist of this disclosure and are included in the scope of the present disclosure recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. A medium processing apparatus comprising:
a tray;
a liquid applier to apply liquid to a medium supported by the tray as an application process;
a crimper to crimp and bind a media bundle including the medium to which the liquid is applied by the liquid applier as a binding process; and
circuitry configured to:
measure an elapsed time after the application process is executed on a first medium of the media bundle;
control the liquid applier to reapply the liquid to the first medium as a reapplication process when the elapsed time reaches a threshold time before a second medium subsequent to the first medium is conveyed to the tray;
control the liquid applier not to reapply the liquid to the first medium as the reapplication process when the second medium is conveyed to the tray before the elapsed time reaches the threshold time; and
control the crimper to execute the binding process on the media bundle including the first medium and the second medium.

2. The medium processing apparatus according to claim 1,
wherein the circuitry is further configured to adjust the threshold time based on at least one of:
a type of the first medium;
a thickness of the first medium;
a humidity of an installation place of the medium processing apparatus;
a room temperature of the installation place of the medium processing apparatus; or
a number of media supported by the tray.

3. The medium processing apparatus according to claim 1,
wherein the circuitry is further configured to adjust an amount of the liquid to be reapplied to the first medium based on at least one of:
a type of the first medium;
a thickness of the first medium;
a number of media supported by the tray; or
a length of the elapsed time.

4. The medium processing apparatus according to claim 3,
wherein the liquid applier includes a liquid application member containing the liquid and presses the liquid application member against the medium supported by the tray for a pressing time to execute the application process, and
the circuitry is further configured to increase or decrease the pressing time to adjust the amount of the liquid to be reapplied to the first medium.

5. The medium processing apparatus according to claim 1, further comprising another tray,
wherein the circuitry is further configured to determine whether:
to execute the reapplication process on the first medium; or
to eject the medium or the media bundle supported by the tray to said another tray without executing the binding process,
when the elapsed time reaches the threshold time before the second medium is conveyed to the tray.

6. The medium processing apparatus according to claim 5,
wherein the circuitry is further configured to determine whether:
to execute the reapplication process on the first medium; or
to eject the medium or the media bundle supported by the tray to said another tray without executing the binding process, based on at least one of:
a type of the first medium;
a thickness of the first medium;
a number of media supported by the tray;
an amount of the liquid contained in the first medium; or
a number of times of the reapplication process executed on the medium supported by the tray.

7. The medium processing apparatus according to claim 5, further comprising an operation panel to receive an input of an operation,
wherein the circuitry is further configured to determine, based on the input of the operation via the operation panel, whether:
to execute the reapplication process on the first medium; or
to eject the medium or the media bundle supported by the tray to said another tray without executing the binding process.

8. The medium processing apparatus according to claim 1,
wherein the circuitry is further configured to reapply the liquid to the first medium in response to the second medium becoming suppliable to the tray,
when the elapsed time reaches the threshold time before the second medium is supplied to the tray.

9. An image forming system comprising:
an image forming apparatus to form an image on a medium; and
the medium processing apparatus according to claim 1.

10. The medium processing apparatus according to claim 9,
wherein the circuitry is further configured to output a notification to the image forming apparatus at:
a timing that the elapsed time reaches the threshold time until the second medium is supplied to the tray; and
a timing that reapplication of the liquid to the first medium is completed.
